(19) United States
(12) Patent Application Publication
(10) Pub. No.: US 2014/0114680 A1
(43) Pub. Date: Apr. 24, 2014

(54) INTERACTIVE HEALTH ASSESSMENT

(71) Applicant: RedBrick Health Corporation, Minneapolis, MN (US)

(72) Inventors: Peter Mills, London (GB); Wendy Masloski, Champlin, MN (US); Ryan Scherf, Richfield, MN (US); Jolene Butler, Minnetonka, MN (US); Carole Bashaw, St. Paul, MN (US); Matt Christianson, Lakeville, MN (US); Mary Beth Edlund, Dayton, MN (US); Sairam Rekapalli, Minnetonka, MN (US)

(73) Assignee: RedBrick Health Corporation, Minneapolis, MN (US)

(21) Appl. No.: 14/138,801

(22) Filed: Dec. 23, 2013

Related U.S. Application Data
(63) Continuation of application No. 12/945,086, filed on Nov. 12, 2010, now abandoned.
(60) Provisional application No. 61/260,728, filed on Nov. 12, 2009.

(51) Int. Cl. G06F 19/00

(52) U.S. Cl. CPC G06F 19/3431
USPC 705/2

(57) ABSTRACT

An interactive health assessment system and method is disclosed. A computer implemented system displays a plurality of health assessment questions to a user; receives an answer from the user for each respective question of the plurality of health assessment questions asked; generates a health score based on the answers received from the user; and provides the user with feedback information regarding the health score.

### CROSS-REFERENCE TO RELATED APPLICATIONS

This application is a continuation of U.S. application Ser. No. 12/945,086, filed Nov. 12, 2010, which claims benefit of priority to U.S. Provisional Application No. 61/260,728, filed Nov. 12, 2009, the contents of each of which are hereby incorporated by reference herein, in the entirety and for all purposes.

### TECHNICAL FIELD

The present disclosure pertains to health care and health care information systems. Specifically, the present disclosure pertains to a computer-implemented interactive health assessment.

### BACKGROUND

Healthcare costs can be expensive. One way to reduce healthcare costs is through healthcare screening where health-related information is collected from individuals and used to improve healthcare management. For example, screening may be used to provide a health risk factor assessment or to provide early detection of disease. This information may allow an individual to get appropriate care in a timely manner. In some cases, receiving early treatment may reduce overall healthcare cost as compared to those costs when certain diseases go undetected or when certain risk factors are ignored. Additionally, in some cases timely treatment may provide a better quality of health and a better quality of life for the individual. In turn, this may result in an individual being more productive on the job, reduced absenteeism, etc.

Unfortunately, healthcare screening can be difficult to conduct, expensive, and time consuming. For example, in some cases healthcare screening requires trained personnel to contact each individual and conduct the screening. Additionally, it can be difficult to get an individual to commit to the block of time required for the person-to-person screening session. In some cases, this can cause individuals to simply avoid the screening process.

In other cases, the individual can be asked to complete a questionnaire that solicits information about health related-issues. However, in some cases, once an individual completes a questionnaire, trained personnel are required to review the completed questionnaire to make a health assessment. Additionally, these questionnaires may be lengthy and time consuming for the individual to complete. Typical assessments may require greater than 20-30 minutes to complete. Consequently, it may be easy for the individual to delay the completion of the questionnaire, forget to take/finish the questionnaire, or avoid taking the questionnaire altogether.

Current health assessments may also suffer from being overly comprehensive. Thus, much time may be wasted gathering minute details about an individual that may not play a large role in the individual's overall health. Typical assessments also seek to gather this information by requiring an individual to “rate” certain aspects of their health, often on a scale, for example, from 1-5 or from 1-10. This may lead to ambiguity in response, or variation in response from one individual to another with similar health issues.

Current health assessment may also fail to keep the user's attention during the assessment by asking “dry” questions and using one-dimensional interaction. Lack of interest may result in the user seeking to “speed through” the assessment, which may result in inaccurate or incomplete responses. Furthermore, even if the user does manage to complete the assessment, the report provided at the end of the assessment is usually just informational in nature with regard to the data collected, and fails to provide any kind of educational or actionable component to the user. Similarly, current web-based health assessments are generally paper-based surveys placed on the Internet. Such health assessments do not take advantage of the various capabilities that the Internet provides, such as interactivity or attention-grabbing techniques. Simply put, existing health assessment surveys, whether paper-based or web-based, simply provide no means to engage the user or otherwise provide an interactive experience.

Thus, there is a need in the art for improved health assessment systems and methods which provide an interactive experience for the user, are consistent from user to user, and are fast and easy to complete while providing a full, educational, and actionable assessment.

### SUMMARY

Accordingly, in one embodiment, the present disclosure describes a method for determining a quantitative assessment of health, which may include displaying, in electronic format on an electronic display device, one or more questions related to a first health condition and a second health condition, receiving, in electronic format, information representing an assessment of the first health condition and the second health condition, the information being provided by user manipulation of an input device, and transforming the information representing the first health condition into a first numerical value and transforming the information representing the second health condition into a second numerical value. The first and second numerical values may represent a quantitative score of the information. The method may further include applying a mathematical algorithm to at least the first and second numerical values. The mathematical algorithm may provide a final numerical score as a function of at least the first and second numerical values.

In another embodiment, the present disclosure describes a method for providing an interactive health assessment, which may include selecting, from an electronic database, a question pertaining to a health condition of a user; displaying, in electronic format on an electronic display device, the question; and receiving, in electronic format, data representing an answer to the first question, the data being provided by user manipulation of an input device. The answer may represent the user's assessment of the health condition. The method may further include selecting, from the electronic database, responsive information pertaining to the answer. The responsive information may represent commentary regarding the assessment of the health condition. Additionally, the method may include displaying, in electronic format on the electronic display device, the responsive information.

In a further embodiment, the present disclosure describes a method for providing an interactive health assessment, which may include selecting, from an electronic database, a question pertaining to a health condition of a user; selecting, from the electronic database, a user engaging feature for association with the question. The user engaging feature may provide a visual representation related to the question. The method may further include displaying, in electronic format on an electronic display device, the question and the user engaging feature and receiving, in electronic format, data representing an answer to the first question. The data may be provided by user manipulation of an input device. Further, the answer may represent an assessment of the health condition.

In still a further embodiment, the present disclosure describes a computer-implemented system for providing an interactive health assessment, which may include a user terminal having an electronic display device, an electronic user input device, and a processor in operable communication with display device and the user input device. The processor may be configured to cause the display device to display a question pertaining to a health condition. The processor may also be configured to receive a user input from the user input device, the user input representing an assessment of the health condition. The processor may additionally be configured to transform the user input into a numerical health score, the numerical health score representing a quantitative assessment of the user's health. Still further, the processor may be configured to cause the display device to display generally immediate feedback information pertaining to at least one of the user input and the numerical health score.

While multiple embodiments are disclosed, still other embodiments of the present disclosure will become apparent to those skilled in the art from the following detailed description, which shows and describes illustrative embodiments. As will be realized, the invention is capable of modifications in various aspects, all without departing from the spirit and scope of the present disclosure. Accordingly, the drawings, figures, illustrations and detailed description are to be regarded as illustrative in nature and not restrictive in any way. Particularly, drawings, figures, and illustrations are provided which depict embodiments of a particular shape. It will be understood that these drawing are meant merely to illustrate example shapes, and many other shapes will be possible, all within the scope of the presently described embodiments in the disclosure.

### BRIEF DESCRIPTION OF THE FIGURES

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is an example computer-implemented system in accordance with one embodiment of the present disclosure.

FIG. 2 is an example health assessment instructions display page in accordance with one embodiment of the present disclosure.

FIG. 3 is an example health assessment privacy promise display page in accordance with one embodiment of the present disclosure.

FIG. 4 is an example health assessment question/answer display page related to a user's general mood in accordance with one embodiment of the present disclosure.

FIG. 5 is an example health assessment question/answer display page related to a user's perception of health in accordance with one embodiment of the present disclosure.

FIG. 6 is an example health assessment question/answer display page related to a user's typical diet in accordance with one embodiment of the present disclosure.

FIG. 7 is an example health assessment question/answer display page related to a user's physical activity in accordance with one embodiment of the present disclosure.

FIG. 8 is an example health assessment question/answer display page related to a user's stress level in accordance with one embodiment of the present disclosure.

FIG. 9 is an example health assessment question/answer display page related to a user's biometrics in accordance with one embodiment of the present disclosure.

FIG. 10 is an example health assessment question/answer display page related to a user's life satisfaction in accordance with one embodiment of the present disclosure.

FIG. 11 is an example score presentation display page in accordance with one embodiment of the present disclosure.

FIG. 12 is an example medical health topic-specific scoring model in accordance with one embodiment of the present disclosure.

FIG. 13 is an example family history topic-specific scoring model in accordance with one embodiment of the present disclosure.

FIG. 14 is an example age topic-specific scoring model in accordance with one embodiment of the present disclosure.

FIG. 15 is an example cardiovascular risk topic-specific scoring model in accordance with one embodiment of the present disclosure.

FIG. 16 is an example nutrition topic-specific scoring model in accordance with one embodiment of the present disclosure.

FIG. 17 is an example weight topic-specific scoring model in accordance with one embodiment of the present disclosure.

FIG. 18 is an example tobacco use topic-specific scoring model in accordance with one embodiment of the present disclosure.

FIG. 19 is an example alcohol use topic-specific scoring model in accordance with one embodiment of the present disclosure.

FIG. 20 is an example sleep topic-specific scoring model in accordance with one embodiment of the present disclosure.

FIG. 21 is an example stress topic-specific scoring model in accordance with one embodiment of the present disclosure.

FIG. 22 is an example risk behavior topic-specific scoring model in accordance with one embodiment of the present disclosure.

FIG. 23 is an example work life topic-specific scoring model in accordance with one embodiment of the present disclosure.

FIG. 24 is an example pain topic-specific scoring model in accordance with one embodiment of the present disclosure.

FIG. 25 is an example outlook topic-specific scoring model in accordance with one embodiment of the present disclosure.

FIG. 26 is an example social support topic-specific scoring model in accordance with one embodiment of the present disclosure.

FIG. 27 is an example score details display page in accordance with one embodiment of the present disclosure.

FIG. 28 is an example recommendations display page in accordance with one embodiment of the present disclosure.

FIG. 29 is an example recommended programs display page in accordance with one embodiment of the present disclosure.

### DETAILED DESCRIPTION

The present disclosure relates to health management and health care information systems. Specifically, the present disclosure relates to a computer-implemented interactive health assessment. The systems, methods, and computer-accessible media disclosed herein provide an improved health assessment suitable for use in various health management or health care applications by individuals, businesses, organizations, governmental entities, and health care providers, among others.

### Computer-Implemented System:

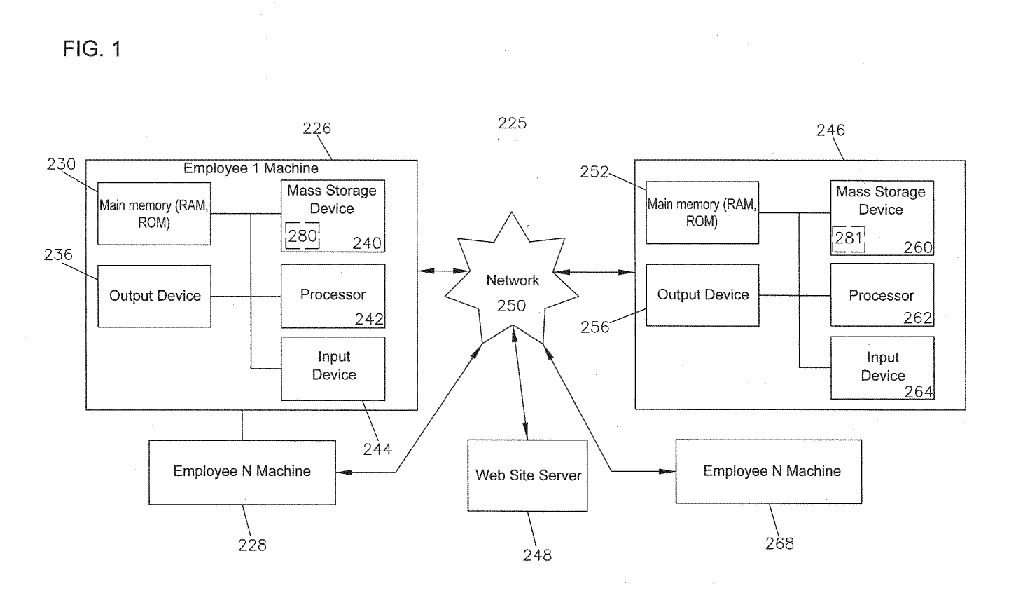

A health assessment in accordance with the present disclosure may be provided by computer-implemented means. FIG. 1 shows an example system suitable for use with the example health assessments disclosed herein. Depicted in FIG. 1 is a diagram of an embodiment of a computing system 225 for implementing a health assessment. System 225 may include a computer access machine 226 connected with a network 250 such as the Internet. Individuals using computer access machine 226 can interact with a server 246 in order to input and receive information, for example but not limited to, viewing and updating individual profiles and completing health assessments, which are described more fully below.

System 225 may also include the ability to access one or more web site servers 248 in order to obtain content from the Internet for use with the health assessment embodiments described herein. While only one computer access machine is shown for illustrative purposes, system 225 may include a plurality of access machines 226 and may be scalable to add or remove computer access machines to or from a network.

Computer access machine 226 illustrates components of an embodiment of a computer access machine. Computer access machine 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250. Input device 244 may include any device for entering information into machine 226, such as but not limited to, a microphone, digital camera, video recorder or camcorder, keyboard, mouse, cursor-control device, touch-tone telephone or touch-screen, a plurality of input devices, or any combination of input devices. Output device 236 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser, may be used to access information for health assessments and display them in web pages, and allow information to be updated, for example. Any commercial or freeware web browser or other application capable of retrieving content from a network and displaying pages or screens may be used. In some embodiments, a customized application 280 may be used to access, display and update information for a user.

Examples of computer access machines for interacting with the system include personal desktop computers, laptop computers, notebook computers, palm-top computers, network computers, or any processor-controlled device capable of executing a web browser or other type of application for interacting with the system, including mobile devices such as cellular phones.

Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260, for example, for storing and maintaining health assessment information and other data. Any type of data structure can be used, such as a relational database or an object-oriented database.

Processors 242, 262 may, alone or in combination, execute one or more applications 280, 281 in order to provide some or all of the functions, or portions thereof, of the health assessment system and method described herein, and as will be discussed in greater detail below.

Employers may monitor system performance, input data, modify parameters of the assessment or scoring model, etc., using output devices 256 and input devices 264 of server 246, or may use one or more remote computer access machines 268, which may communicate to server 246 directly, or via a network 250, for example.

As will be appreciated by those having ordinary skill in the art, the present disclosure is not limited to systems such as shown in FIG. 1, but may also include personal computers, hand-held devices, kiosks, wireless devices, network systems, and multimedia components, among others, alone or in various combinations.

The health assessment may be stored and coded in the form of a computer-implemented application. The application may be stored in a computing system as in FIG. 1, on a computer-accessible medium, on a hard drive, on a network storage facility, or on any other suitable data storage means. However stored, the application may be easily accessible to a user without having sophisticated knowledge of the system on which it is stored.

### Beginning the Health Assessment:

The user may begin the health assessment by initiating the application. Alternatively, the application may be initiated by the provider of the assessment prior to the user's arrival, such that the user arrives at the computer-implemented system with the health assessment application active and ready to commence the assessment. The application may require user verification, such as through a previously created account with password protection.

The health assessment application may be designed so as to be viewable from a typical computer screen or other standard display, such as using output device 236. The application may provide the assessment in one or more windows on the screen or display. Within each window the application may provide one or more of the following to the user: instructions, prompts, graphics, icons, questions, answers, commentary, suggestions, feedback, dialogues, selection boxes, radio buttons, data entry fields, menus, drop-down menus, sliding scales, progress indicators, and other display configurations as will be understood by those having ordinary skill in the art. The user/application may provide/receive data and information via this display, with the aide of speakers, mouse, keyboard, joystick, printers, and/or other standard computer peripherals, such as input device 244.

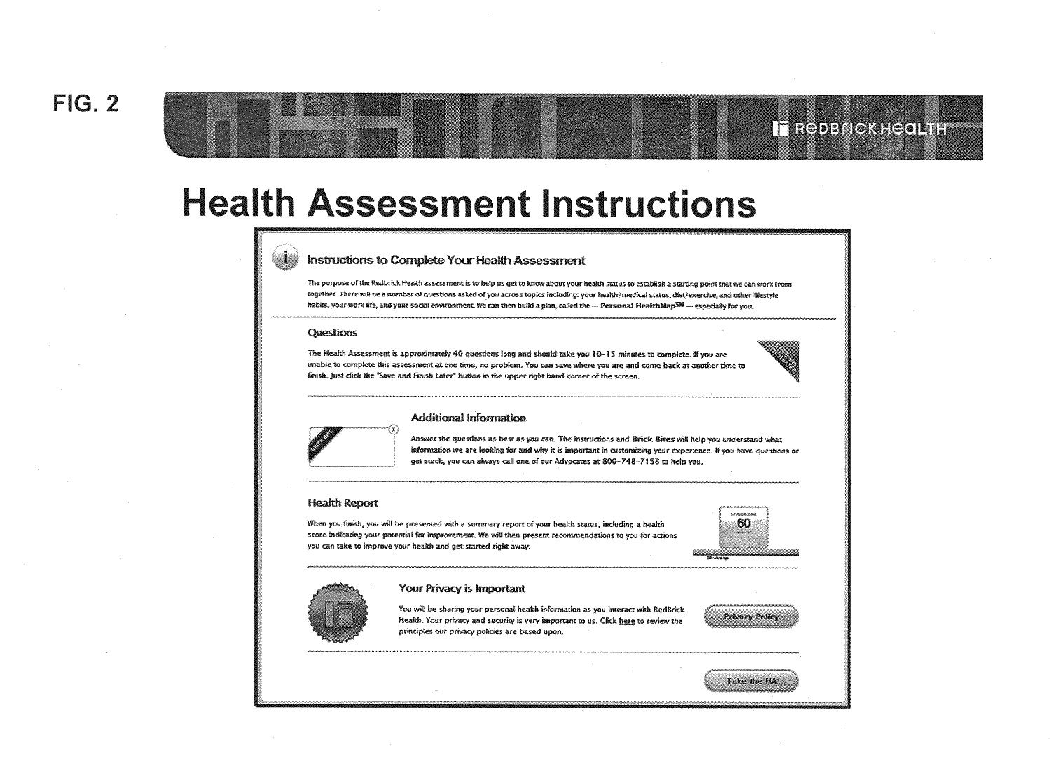

In some embodiments, the assessment may commence with an instruction display. The instruction display may provide the user with instructions needed to complete the assessment. The instruction display may include information regarding, for example, the purpose of the health assessment, the estimated length of time to complete the assessment, the answering of questions, who to contact in case help is needed, finishing the assessment including receiving a report and score, and personal privacy, among other information. One embodiment of an instruction display is depicted as FIG. 2.

In one embodiment, as shown in FIG. 2, an instruction page may be displayed to the user in any style, including a paragraph/list format. Contained thereon, a paragraph instructing the user on how to complete the assessment may be displayed to provide the user with information concerning the steps required to complete the assessment. A user question paragraph may inform the user of the number of questions to be asked, along with the approximate time required for completion. Furthermore, the user question paragraph may inform the user about how to save questions answered during the assessment, if the user wishes to complete the assessment in parts or at different times. Additional information may be provided to the user on this page, including contact information for assistance in case the user encounters difficulties in taking the assessment. Additionally, a paragraph or other form concerning a health report may inform the user about a score or report which may be provided to the user upon completion of the assessment. Additionally, a paragraph discussing privacy may inform the user of the operator's privacy policy with regard to the user's answers and personal information.

Each page displayed by the health assessment system may provide one or more graphical icons or similar buttons which, when selected by the user, moves the display to a subsequent page, or back to a previous display. Once finished with a display, the user may move to a subsequent display page by, for example, clicking a “next” or similar button on a display using a mouse or other peripheral device. The user may revisit a previous display by, for example, clicking a “previous” or similar button on a display. Alternatively, the application may provide a means to change to a specific display page by appropriate selection. For example, the previously discussed user instructions page may display an icon, which, when selected by the user, automatically begins the health assessment. Such an icon is depicted in FIG. 2, in one embodiment as “Take the HA.”

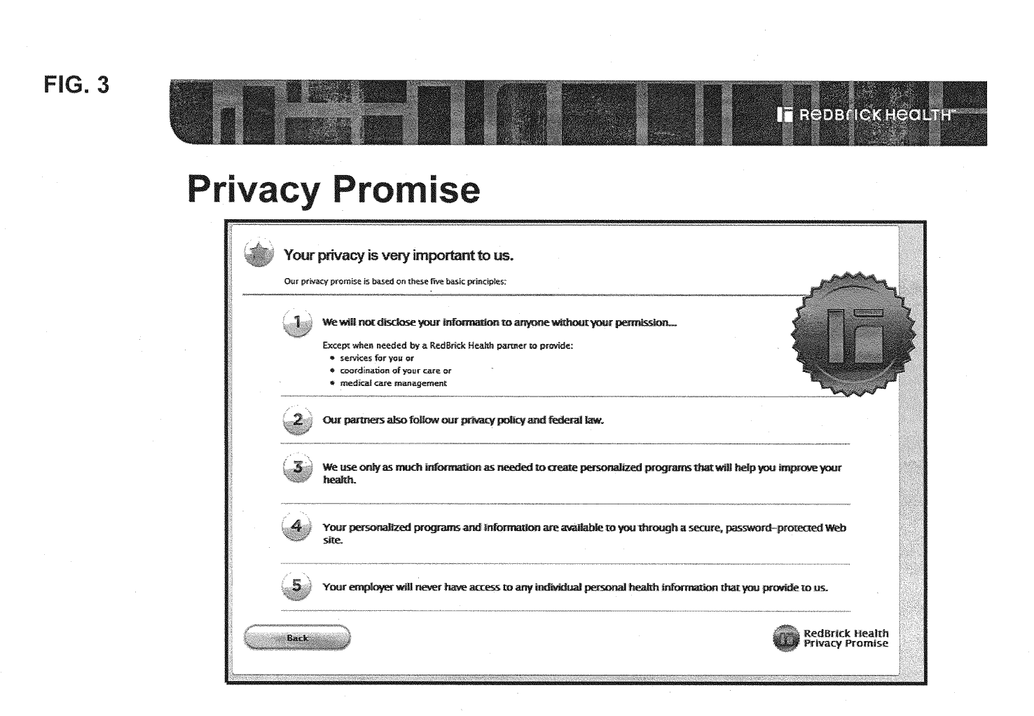

Prior to displaying any health related questions, the health assessment application may provide the user with a display relating to privacy policies. The privacy display may provide the user with information concerning the assessment provider's privacy policy, or other privacy related information. The display may include information concerning disclosure of personal information, partner policies, use of information, security and password protection, and employer access, among other considerations. A representative privacy display, in one embodiment, is depicted as FIG. 3.

As depicted in FIG. 3, a privacy related display page may display a numbered list of important or relevant privacy related information. Such information may include, among others, permission-based disclosure of information, and any exceptions related thereto; issues of federal or state law; the extent to which health information provided may be used; security policies related to the access of personal or health related information; and/or employer access to the personal or health related information. Displaying such privacy information prominently, and prior to beginning the assessment, may encourage the user to provide more accurate information, thus resulting in a more accurate assessment.

### Health Questions:

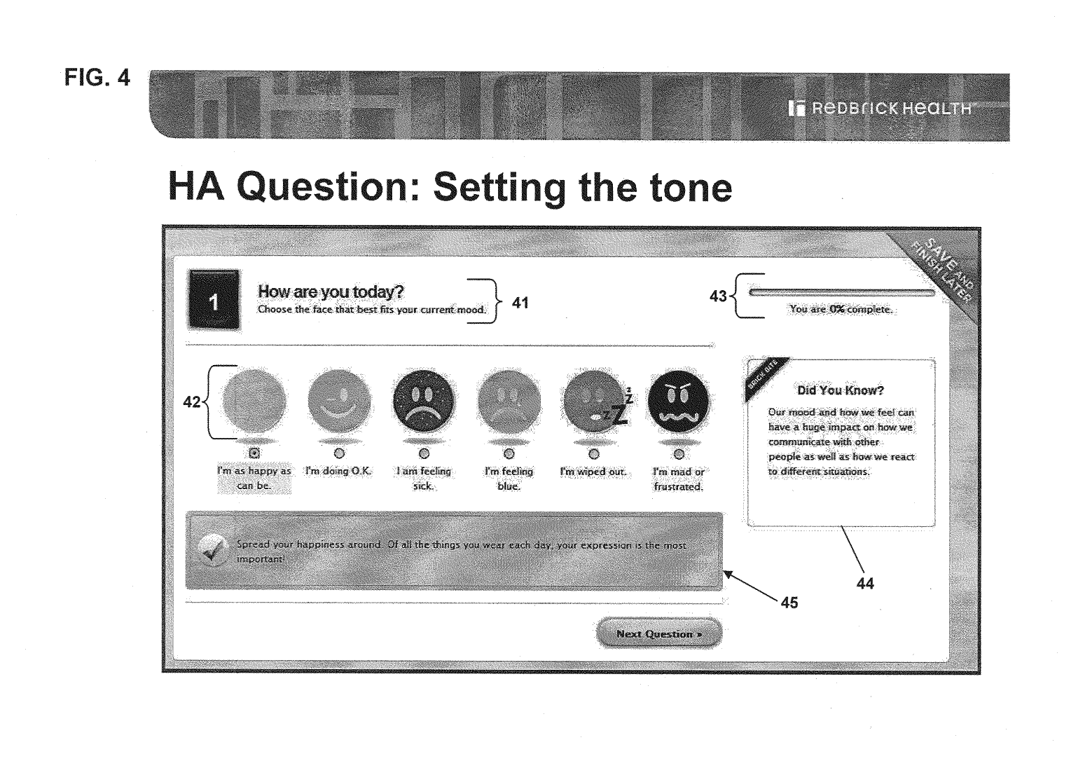

Health-related questions may be provided to a user on one or more display pages. Questions may be provided in the form of a written dialogue on the display, along with a question sequence number. An example question display page is provided as FIG. 4, with the question/sequence number shown as reference numeral 41. Questions may solicit information from a user in a plurality of health-related topic areas. These topic areas may include, for example, health attitudes (perception of health), profile (age, gender, and communication preferences), pregnancy, nutrition (diet, alcohol, caffeine), physical activity, sleep, stress (amount, ability to cope), pain (where, severity), tobacco (types and/or use), conditions and biometrics, preventive care, work life (satisfaction, productivity) family history, social/behavioral (family and community situation), other risks, or any other topic area which may pertain to an individual's health or well-being. A detailed description of representative questions in these topic areas is provided at later points in this description of embodiments.

Also provided to the user on a question page may be possible answers from which the user may select one or more answers that the user feels suitably respond to the question asked. Answers may be provided in the form of written responses on the display. Alternatively or additionally, answers may be provided in the form of graphics/icons which provide a pictorial representation of the answer. Pictorial representations may assist the user in answering the question, may provide for more uniform answers between users (as opposed to the 1-5 or 1-10 scale/range type answer), and may serve to engage the user visually so as to keep the user interested in completing the assessment. For example, a question related to a user's mood may have answer choices which display a “happy face” if the user's mood is happy, a “sad face” if the user is feeling sad, and other similar icons associated with the answer text. Further, a question related to a user's typical diet may have answer choices which display a graphic of the food associated with the answer text. An example answer display with pictorial representations is depicted in FIG. 4 as reference numeral 42. Further discussion of specific examples of such graphics and icons will be provided in greater detail below in connection with the discussion of representative questions. Answers may be selected/entered by the user clicking on an icon, graphic, radio button, check box, drop-down menu, sliding scale, or similar configuration.

Alternatively, answers may be provided by the user entering specific data into one or more data entry fields on the display, in situations where selecting among possible answers is not desirable or suitable. For example, a question asking a user to provide their total cholesterol number may not be suitably or accurately answered by selecting from among possible answers. Rather, a data entry field may be appropriate to allow the user to provide the numeral answer. In another example, if the user is asked to enter personal information, such as name, address, etc., data entry fields may be the most appropriate means to enter text representing the user's name, address, etc. Such data may be entered by the user through means of a keyboard or other peripheral device, as described with respect to FIG. 1, adapted to allow the input of data. An example data entry field is depicted in FIG. 9 as reference numeral 91.

In an additional alternative, the user may be presented with the option not to answer a question. This option may be presented visually as a “prefer not to respond” option or any other suitable manner indicating that the user has chosen not to respond to the question.

In some embodiments, questions may include sub-questions, or subsequent questions, which depend on the answer to the previous question, or are only asked depending on the answer to a previous question. Such questions may be referred to as conditional questions. For example, a question relating to how often a user drinks alcohol may only be appropriate to present to a user who had previously answered in the affirmative to a question asking whether the user drinks alcohol. Similarly, a question relating to pregnancy may only be appropriate if the user has previously answered “female” to a question soliciting the user's gender. Conditional questions may be displayed on the same page as the previous question, appearing after the response is provided necessitating the conditional question, or they may be provided on subsequent displays.

Provided with each health assessment question display may be a progress indicator. A progress indicator shows the user how far the user has progressed in the assessment. This may be indicated by, for example, percentage complete, questions complete out of total questions, a graphical indicator, such as a progress bar/graph, or other suitable indication. An example progress indicator is shown in FIG. 4 as reference numeral 43.

In conjunction with each question/answer set, a question display in accordance with the present disclosure may also present additional helpful information regarding the applicable health topic to the user in the form of commentary. This commentary may assist the user in answering the question, or it may provide information pertinent to the user's health or well-being, among other things. Furthermore, this commentary may provide an additional component of interactivity with the user, helping to keep the user interested in the assessment, as well as further educate the user with information that may improve health. Commentary may be presented on the display in a separate dialogue box, and may appear before or after the question has been answered by the user. An example commentary display is depicted in FIG. 4 as reference numeral 44.

After the user has answered a question, the display may provide an additional level of interactivity by providing commentary specifically directed to the user's answer. Such commentary may appear in a dialogue box or pop-up window on the display, which appears once the user has selected/entered an answer(s) to the question. Such answer-specific commentary may, among other things, provide the user with additional information concerning the user's health based on the user's selected answer, it may congratulate the user if the answer indicates a positive health condition, it may suggest possible remedies to the user if the answer indicates a negative health condition, or it may provide the user with information concerning additional resources that the user may seek after completing the assessment to improve or modify a health condition or health-related behavior. An example answer-specific comment is depicted in FIG. 4 as reference numeral 45. In one embodiment, after a question has been answered, the user may be substantially immediately (e.g., in real time) provided with a link or contact information for health-related resources or services if the user's answer indicates that such resources or services may benefit the user. For example, a user who indicates that they have depression may be immediately provided with contact information for mental health or psychological services upon answering such question in the health assessment. The link or contact information may allow the user to sign up for or use the health-related resources or services substantially immediately.

As will be appreciated by those having ordinary skill in the art, any of the display components, including the question, answers, graphics, icons, commentary, dialogue boxes, windows, etc., may be presented to the user in a dynamically moving fashion. This may include a sweeping movement from the left/right/top/bottom, pop-up motion, flashing, color/size change, rotation, translation, or any other type of movement as may be desired. The dynamic nature of the display components may provide the health assessment an additional component of user interactivity, as well as keeping the user's attention focused on the assessment throughout the entire process.

### Example Displays:

Reference will now be made to specific examples of computer-implemented displays which may be presented to a user in a health assessment in accordance with the present disclosure. As will be appreciated, these displays, and the questions/answers/commentary described therein, are merely representative examples, and unless otherwise indicated, are not intended to be limiting on the type, number, topic, breadth, or specificity of displays, questions, answers, or commentary which may comprise a health assessment within the spirit and scope of this disclosure.

In a question display related to the user's overall mood or condition, the application may be configured to provide the user with a question concerning how the user is feeling that day in a general sense. For example, the user may be asked how they are feeling that day, or the user may be asked to describe their current mood. In some embodiments, prior to or concurrently with providing the user with the mood or condition question display, the application may be configured to provide the user with commentary regarding the question. Such commentary may seek to inform the user of the importance of a person's overall mood or condition as related to their health. For example, the user may be provided with a comment concerning how mood may be related to personal health, or how mood may be related to interaction or communications with others. In a response display to the mood or condition question, the user may be provided with various response options. For example, in one embodiment, the user may be asked to select from responses which may include being happy, just O.K., feeling sick, feeling depressed or sad, feeling tired, feeling mad or frustrated, and/or other general mood or condition responses. In connection with each possible response displayed, the user may be shown computer generated icons depicting a pictorial representation of each response. For example, a happy face icon may be provided in connection with a response for the choice of feeling happy. Other representative icons may be provided with the other responses. The application may be configured to require the user to select a response before further questions will be displayed. In some embodiments, after the user has answered the mood or condition question, commentary may be provided to the user commenting on their selected answer. Such commentary may seek to provide the user with additional details, feedback, or options regarding their selected mood or condition. For example, in connection with the example responses discussed above, the application may display answer-specific commentary, such as but not limited to: a comment regarding the importance of happiness; a comment regarding the importance of taking care of oneself when sick, including drinking fluids and getting rest in order to recover more quickly; a comment regarding the importance of doing physical activity when tired or depressed due to natural chemicals which are released during exercise which may improve the user's condition; a comment relating to the commonness of sleep difficulties, and that suggestions provided within the health assessment may help to improve sleep difficulties; and/or any other commentary which may respond to the user's selected answer. An example display relating to the user's overall mood or condition is depicted as FIG. 4.

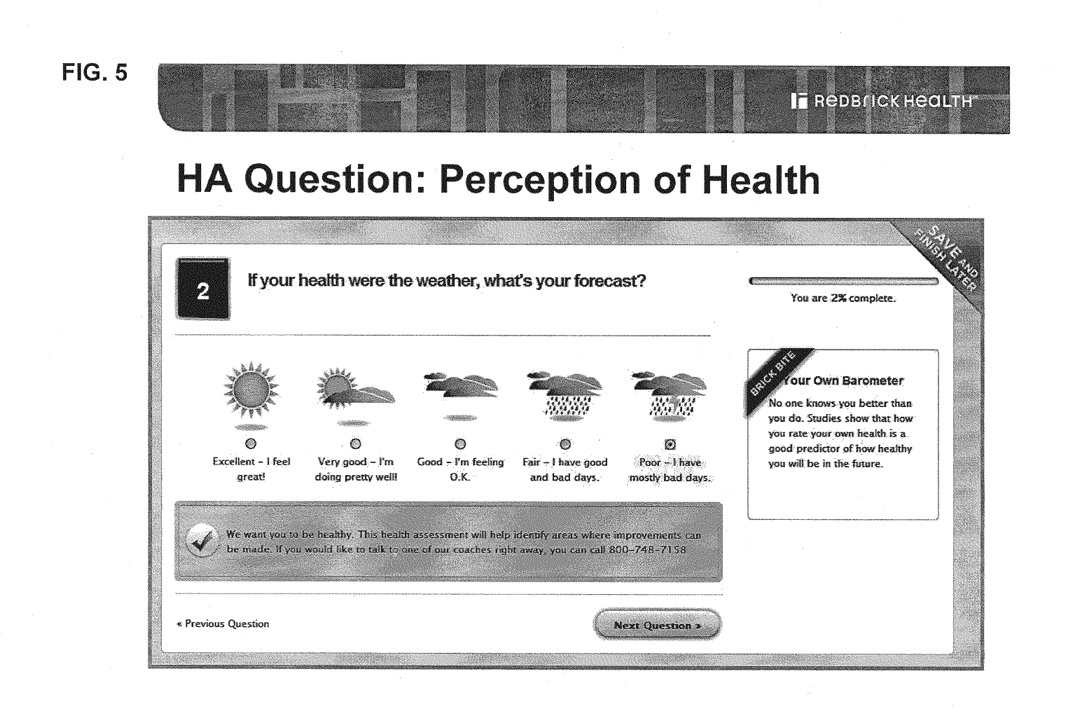

In a question display concerning a user's personal attitude toward health, the application may be configured to provide the user with a question concerning the user's personal perception of their current health. For example, the user may be asked to describe their health in relation to generally understood concepts which may be easier for the user to assess, such as the weather. In some examples, the user may be asked to describe their personal “forecast.” In some embodiments, prior to or concurrently with providing the user with the personal health attitudes question display, the application may be configured to provide the user with commentary regarding the question asked. Such commentary may seek to inform the user of the importance of a person's own perception of their health as a predictor of future health. For example, the user may be provided with commentary relating to the fact that the user may be the best source of information concerning their overall health condition now and in the future, based on their own perception of their health. In a response display to the personal health attitudes question, the user may be provided with response options to the question. For example, the user may be asked to select from responses which may include excellent, very good, good, fair, poor, or any other descriptive of a personal health attitude. Accompanying each choice may be a descriptive phrase concerning the choice. For example, accompanying an excellent attitude selection may be a phrase stating that the user usually feels great during the day. Other phrases may be provided corresponding to other possible responses. In connection with each possible response, the user may also be shown computer generated icons depicting a pictorial representation of each response. For example, a sunshine icon may be provided in connection with a good or excellent response. Alternatively, a rain cloud may be provided in connection with a fair or poor response. Other representative icons may be provided with the other responses in a like fashion. The application may be configured to require the user to select a response before further questions will be displayed. In some embodiments, after the user has answered the personal health attitudes question, commentary may be provided to the user commenting on their selected answer. Such commentary may seek to provide the user with additional details, feedback, or options regarding their selected health attitude or perception. For example, in connection with the example personal health attitudes responses discussed above, the application may display one or more comments, including an encouragement to keep up the good work, a suggestion that the user take steps to feel better, contact information concerning help that may be available to assist the user in improving their personal health and health attitudes, information describing to the user how the health assessment may help them identify areas where improvement may be made, or other relevant commentary or suggestions. An example display concerning the user's personal perception of health is depicted as FIG. 5.

In a question display concerning the user's personal profile, the application may be configured to provide the user with a question concerning the user's gender, date of birth, or other personal profile information. For example, the user may be asked to confirm their gender and/or birthday, or other identifying characteristics. In some embodiments, prior to or concurrently with providing the user with this profile question display, the application may be configured to provide the user with explanatory commentary regarding the profile question. Such commentary may seek to inform the user of the importance of a person's gender and age, or other personal information, as it relates to their health. For example, the user may be provided with a comment informing the user that gender and age may affect the user's risk of disease, and by providing such information, the health assessment may better be able to provide the user with relevant and useful health recommendations. In the response display to the question concerning the user's personal profile, in a first alternative, the user may be provided with response options to the “Profile” question. For example, the user may be asked to select from male or female to indicate their gender. The user may also be provided a field in which to enter their date of birth in any standard format. Other information may be entered in a like manner. In a second alternative, a database may have stored thereon the user's gender and date of birth, and other personal profile information. The user may be asked to confirm whether this information is correct. If not, the user may be provided with an option to change the information, wherein the user is allowed to change their profile information in a manner as discussed with regard to the first alternative. The application may be configured to require the user to select a response before further questions will be displayed. After the personal profile information has been entered/confirmed, the application may provide the user with information regarding updating their profile information. For example, the user may be provided with a comment thanking the user for entering or confirming their information, and further that the user may contact a human resources department at their employer, or contact another representative, if any of the personal profile information should change.

In a question concerning the user's race, ethnicity, or other personally identifying characteristics, the application may be configured to provide the user with a question asking the user to identify one or more of such characteristics. For example, the user may be asked to identify their race or ethnicity, or other identifying characteristics, and to select from among the choices that may apply to the user. In some embodiments, prior to or concurrently with providing the user with a race or ethnicity question display, the application may be configured to provide the user with commentary regarding the race or ethnicity question. Such commentary may seek to inform the user of the importance of a person's race, ethnicity, or other personally identifying characteristics as it pertains to the propensity for disease. For example, the user may be provided with a comment detailing to the user why their race and/or ethnicity may matter to their health, such as, for example, because many health conditions are more common in people of certain races or ethnic origins. And further, by providing this information, the user may be informed that the health assessment may be able to provide the user with relevant and useful health recommendations. In a response display to the race or ethnicity question, the user may be provided with corresponding response options. For example, the user may be asked to select from responses which may include, among others, that the user prefers not to answer, Hispanic or Latino, Black or African American, Caucasian or White, Asian, Native Hawaiian or Pacific Islander, American Indian or Alaska Native, or Other, among other choices. The application may be configured to require the user to select a response before further questions will be displayed. In some embodiments, more than one response may be selected.

In a question display concerning pregnancy, which may be made conditional on the user's response to the previously discussed gender and age question, the application may be configured to provide the user with a question asking whether the user is pregnant, or plans to become pregnant. In some embodiments, this question may only be provided to users who have indicated in the previously discussed personal profile question that their gender is female, and in further embodiments, if their age is between 18 and 45. For example, the user may be asked whether the user is pregnant or plans to become pregnant. In a response display to the pregnancy question, the user may be provided with response options to the pregnancy question. For example, the user may be asked to select from among the following responses, which may include, among others, that yes—the user is currently pregnant, no—the user is not currently pregnant, or that the user is planning to become pregnant in the future, for example, within the next six months, or any other relevant time frame. If the user indicates pregnancy, in one embodiment, a sub-question may then be provided asking the user to specify the stage of pregnancy. For example, the user may be provided with choices from which to select, including first, second, or third trimester, or any other relevant stage of pregnancy. The application may be configured to require the user to select a response before further questions will be displayed. In some embodiments, after the user has answered the pregnancy question, commentary may be provided to the user commenting on their selected answer. Such commentary may seek to provide the user with additional details, feedback, or options regarding family planning. For example, in connection with the example responses to this question discussed above, the application may display a comment congratulating the user on their pregnancy, if they have indicated pregnancy, and informing the user of resources that may be available to the user, such as a health coach or other assistance, and links to, or information for, the contact information for the provided resources. The user may also be provided with the same or similar resources if the user has indicated that they are planning to become pregnant.

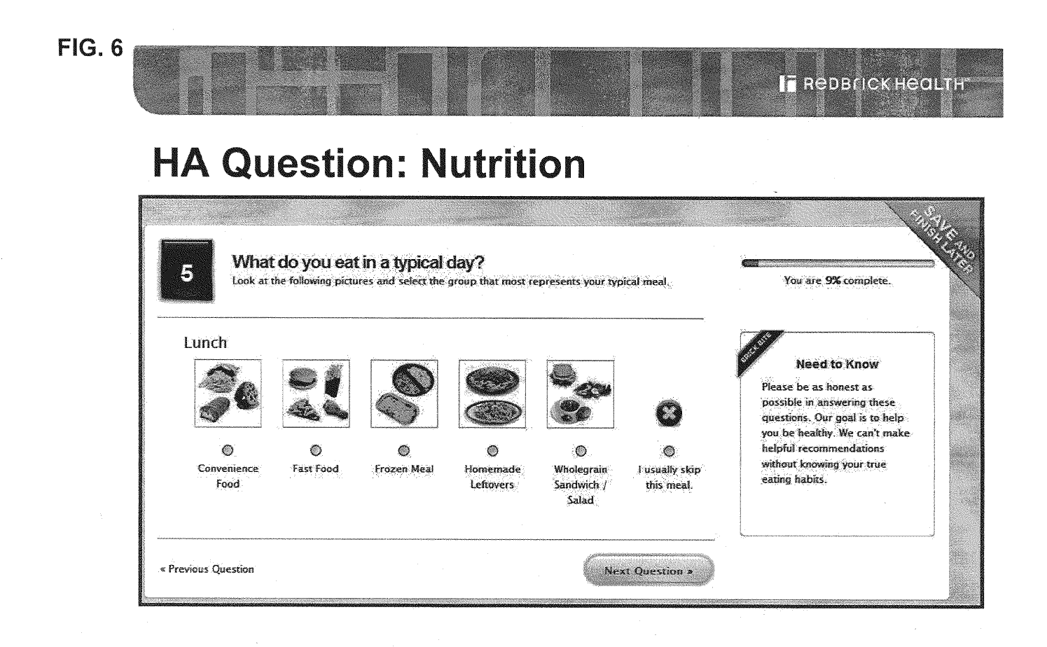

In a question display concerning nutrition, the application may be configured to provide the user with a question concerning the user's typical eating habits. For example, the user may be asked what the user eats during a typical day, week, or other time frame. In some embodiments, the user may be prompted to view pictorial groupings of food which represent a wide variety of eating habits, in order to assist the user in answering the question. In some embodiments, prior to or concurrently with providing the user with the nutrition question display, the application may be configured to provide the user with commentary regarding the question. Such commentary may seek to inform the user of the importance of the food a person eats as it relates to their overall health, or the importance of answering the questions honestly as it relates to the accuracy of the assessment. For example, the user may be provided with the comment that the user should seek to be as honest as possible with regard to answering the nutritional questions, and that recommendations provided by the health assessment may not be as helpful if the user does not provide a true or accurate assessment of their personal nutrition habits. In a response display to the question concerning nutrition, the user may be provided with various responses from which to choose. For example, the responses may be directed to a person's eating habits on a day-by-day basis, or on a meal-by-meal basis, or any other relevant period of time. In embodiments where responses on a meal-by-meal basis are provided, responses for each of breakfast, lunch, dinner, may be provided. For example, the user may be asked to select from the among several breakfast responses, which may list typical foods, including, among others, candy, chocolate, chips or other convenience food; shop-bought cakes, muffins or pastries; full American breakfast, including leftovers from the previous night like pizza or fried chicken; fresh fruit, low fat granola bar, or low fat yogurt; high fiber breakfast cereal (like bran flakes, oats or granola), wholegrain toast and/or a boiled egg; or any other grouping of food that a user may find related to their personal eating habits. Furthermore, the user may be asked to select from among several example lunch responses, which may list typical foods, including, among others, candy, chocolate, chips, or other convenience food; food bought from fast food outlets like a hamburger and fries, fried chicken, or pizza; supermarket bought frozen or microwaveable meals; leftovers from a home prepared dinner such as a pasta dish, a stir fry and rice dish, or a meal the user may make at home especially to take to work; a salad with low fat dressing, a sandwich made with wholegrain bread containing salad and lean meat or fish (no mayo), or a bowl of soup with wholegrain bread; or any other grouping of food that a user may find related to their personal eating habits. Additionally, the user may be asked to select from the following example dinner responses, which may list typical foods, including, among others, food bought from fast food outlets like a cheeseburger and fries, fried chicken, pizza or takeout such as a Chinese or Mexican meal; barbecued hot-dogs, hamburgers, or bratwursts; supermarket bought frozen or microwaveable meals or home fried foods like fried chicken; a sandwich made with wholegrain bread with added salad or vegetables; a home prepared meal with lean meat and vegetables, a home prepared salad with low fat dressing, or a fish dinner; or any other grouping of food that a user may find related to their personal eating habits. In connection with each possible nutritional response, the user may be shown computer-generated icons depicting a pictorial representation of each response. For example, a cheeseburger and fries icon may be provided in connection with an example response relating to lunch or dinner, or other appropriate meal. Other representative icons may be provided with other example responses in a like fashion. The application may be configured to require the user to select a response before further questions will be displayed. Alternatively, the user may indicate that a particular meal is usually skipped. An example display concerning nutrition is depicted as FIG. 6.

In a question display related to snacking, the application may be configured to provide the user with a question concerning the user's typical snacking habits. For example, the user may be asked how the user would describe a normal snack that the user may eat, and to select from among a group of pictorial icons that most represents the user's typical snack. Additionally, the user may be provided with a sub-question related to snacking concerning the user's average amount of snacks eaten in a given day. For example, the user may be asked how many times per day, or other relevant time period, on average, the user snacks. In a response display to the snacking question, the user may be provided with response options to any snack-related questions/sub-questions. With regard to the number of snacks a user eats, for example, this information may be solicited by a drop-down graphic having numbers displayed therein, for example, from 0-3, or it may be provided in an entry field. Other similar means may be provided to the user. With regard to the typical content of a snack, for example, if the user has selected/entered a number greater than zero, the user may be asked to select from among several snacking content responses, which may include, among others, candy, chocolate, chips, or other convenience food; shop-bought cakes, muffins, or pastries; a quick bowl of cereal (like wheat flakes or a chocolate-based cereal), slice of white toast; low fat granola or protein bar, home made scone; cut up vegetables, fresh fruit, dried fruit, low-fat yogurt, or unsalted nuts; or any other grouping of food that a user may find related to their personal snacking habits. In connection with each possible response, the user may be shown computer generated icons depicting a pictorial representation of each response. For example, a candy bar icon may be provided in connection with response wherein a candy bar is listed. Other representative icons may be provided with the other responses in a like fashion. The application may be configured to require the user to select a response before further questions will be displayed. Alternatively, the user may indicate that a particular meal is usually skipped.

In a question display relating to alcohol, the application may be configured to provide the user with a question concerning the user's alcohol consumption. For example, the user may be asked whether the user drinks alcoholic beverages, and if so, how often. In a response display to the alcohol consumption question, the user may be provided with response options to the question. For example, the user may be asked to select from among the following responses, which may include, for example, yes, no, occasionally, e.g. less than once per week, or any other quantity for a given time period. In some embodiments, if the user has indicated that they drink alcohol, the application may be configured to provide the user with commentary regarding the alcohol question. Such commentary may seek to inform the user of the alcohol content of various drinks so that the user may answer the question more accurately. Such commentary may also invite the user to think about how much alcohol they typically drink. The user may also be provided with commentary regarding typical serving sizes of alcoholic beverages, for example in a pictorial representation, which may include wine glasses, shot glasses, beer bottles, or other typical alcoholic beverage servings. Other representative icons may be provided with the other responses in a like fashion. Accompanying each picture may be a descriptive phrase concerning the typical amount of alcohol which may be found in each depicted drink, for example, a large glass of wine or strong beer (e.g., more than 5.5% alcohol by volume) may be indicated as having more alcohol than light beer or a smaller mixed drink. Additional commentary may be provided. For example, the application may suggest that the user think about a typical week, or other relevant time period, and think about how many and what type of alcoholic beverages the user usually consumes during that time period. In some embodiments, the application may ask the user to also think about how many non-alcoholic beverages they drink in a typical day. For example, the user may be provided with a question how many and what type of non-alcoholic beverages the user drinks in a typical day, or other relevant time period. Concurrently with providing this question, a commentary display may be provided which seeks to inform the user of the importance of drinking enough water/water containing drinks during the day. For example, commentary may be provided concerning the fact that a human body consists of more than 60% water, that every bodily system relies on water, and that lack of water can lead to dehydration, which may drain energy and make the user feel tired. Such commentary may also advise the user to drink an adequate amount of non-alcoholic beverages, for example, eight 8-ounce glasses of water each day, or other generally accepted amount.

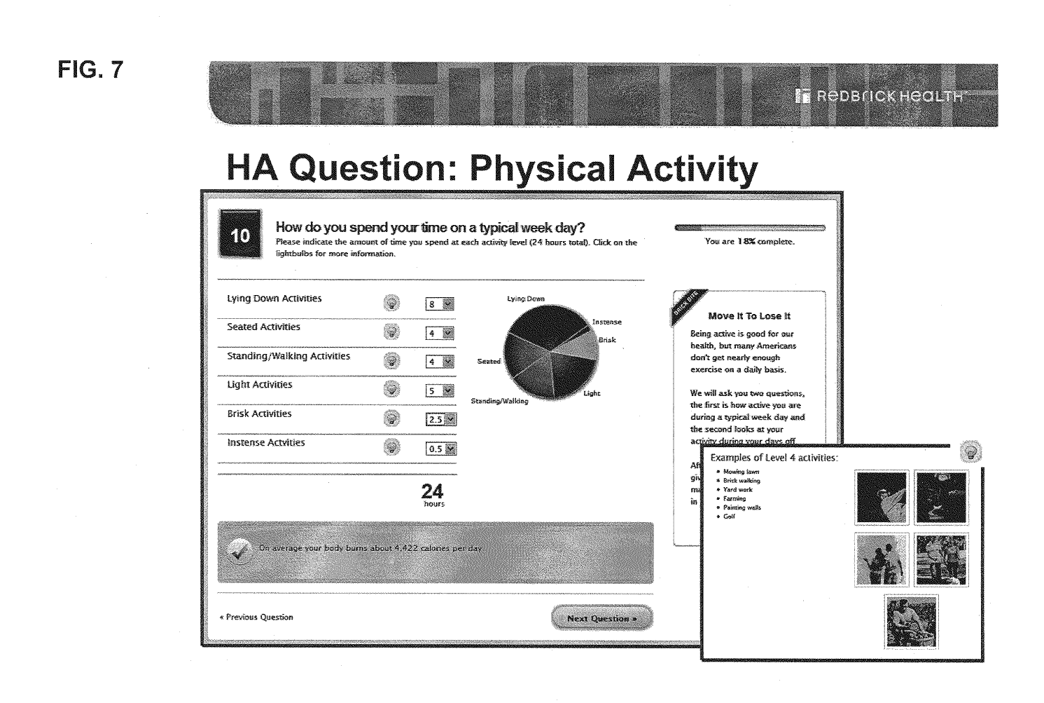

In a question display related to physical activity, the application may be configured to provide the user with a question concerning the user's overall activity level. For example, the user may be asked what kinds of activities the user is involved with each day, week, or other time frame. In some embodiments, the user may be asked how much time, on an average day, the user spends lying down, seated, standing/walking, doing light activities, doing brisk activities, doing intense activities, or doing any other types of physical activities. In connection with each such activity, examples may be provided to the user which describe the activity. For example, with regard to light or brisk activities, mowing the lawn, walking, yard work, farming, painting or golf may be presented to the user as sample activities that would fall into the category. Other examples may be provided in a like manner. The user may also be asked if the user has a disability or any other condition which may prevent the user from engaging in some physical activities. Prior to or concurrently with providing the user with the physical activity display page, the application may be configured to provide the user with commentary regarding the question. Such commentary may seek to inform the user about the effect that physical activity has on the user's weight, energy, or other health-related conditions. For example, a comment may be provided to the user indicating that being active is good for health, but that many people do not get enough exercise or other physical activity in an average day. In a response display to the physical activity question, the user may enter a time associated with each respective activity asked, for example, by field entries, drop down menus, or any other data entry means. In one embodiment, the response display may be separated into weekday/weekend physical activity amounts. In some embodiments, a pie chart or other display graphic or figure may be provided along with the answer display so that the user's entries may be visually depicted to the user, which may allow the user to have a better understanding of how they spend their day in relation to their level of physical activity. The application may be configured to require the user to enter or select one or more responses (e.g., time entries) before further questions will be displayed. In some embodiments, after the user has answered the physical activity question, commentary may be provided to the user commenting on their selected or entered answers. For example, based on the selected or entered amount of time with respect to each physical activity, the application may be configured to calculate the average number of calories the user burns on an average day. The calculation may be based upon caloric burn rates associated with each activity, as will be appreciated by those having ordinary in the art. An example physical activity display page is depicted at FIG. 7.

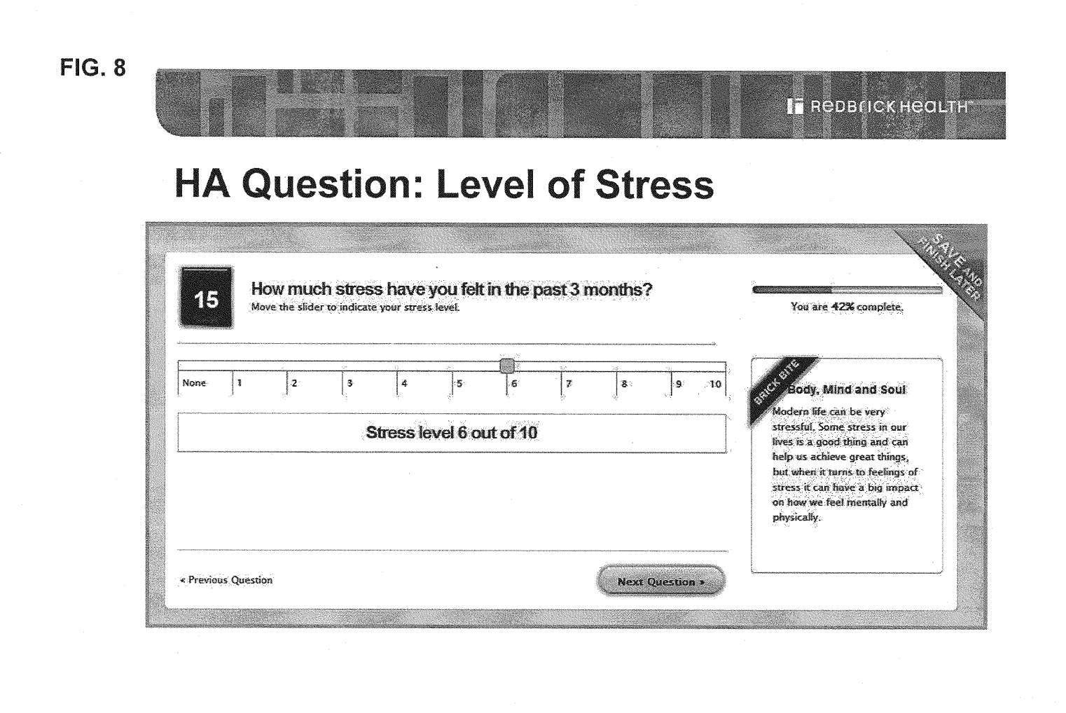

In a question display relating to stress, the application may be configured to provide the user with a question concerning the level of stress that the user is experiencing, or has recently experienced. For example, the user may be asked to indicate a level of stress on a scale, for example, from 1 to 10, by verbal descriptors, or by any other means. Prior to or concurrently with providing the user with the stress question, the user may be provided with commentary relating to the effect that stress may have on the user's life. For example, the user may be provided with information that modern life can be stressful, and that while some stress in life may be beneficial, too much stress may have a big impact on how the user feels mentally and physically. In a response display to the stress question, the user may be provided with a means to indicate their level of stress. For example, if the stress question is provided on a scale from 1 to 10, the response display may be provided on a corresponding sliding scale on which the user can position an indicator icon, indicating the user's level of stress. Other entry fields may be provided in other examples corresponding to the manner in which the stress question is asked. The application may be configured to require the user to enter or select one or more responses before further questions will be displayed. An example stress display page is depicted at FIG. 8. In some embodiments, the stress question may have one or more sub-questions. For example, the user may be asked to indicate the perceived causes of the user's stress, and/or how the user is handling such stress. Responses may be provided by the user to such sub-questions by, for example, checking boxes next to each cause/coping mechanism, data entry fields, drop-down menus, or any other means.

In a question display relating to biometrics, the application may be configured to provide the user with a question concerning the user's vital health numbers or whether the user has been diagnosed with certain health conditions. For example, the user may be asked to enter, update, or confirm the user's vital health numbers. The user may also be asked to indicate whether he/she has been diagnosed with certain health conditions, for example but not limited to, diabetes, asthma, coronary artery disease, congestive heart failure, cancer, high cholesterol, allergies, arthritis, anxiety, stroke, depression, etc. In some embodiments, prior to or concurrently with providing the user with the question display concerning biometrics, the application may be configured to provide the user with commentary regarding the biometrics question. Such commentary may seek to inform the user of the importance of knowing and monitoring vital health conditions. The commentary may also seek to inform the user of the importance of regular physical examinations in order diagnose health conditions early. For example, the user may be provided with commentary indicating that knowledge of basic biometric measurements may allow the health assessment to more accurately assess the user's current state of health, including the user's risk for certain diseases or conditions. In a response display to the biometrics question, in a first alternative, the user may be provided with the option to enter any known health conditions. Biometrics which may be entered by number may include, for example, height, weight, HDL, LDL, Total cholesterol, triglycerides, blood glucose, blood pressure (systolic/diastolic), waist circumference, and/or other vital health information. The application may validate numbers input by the user. Entry of known health conditions may be provided by selection menus, check boxes, field entries, or any other known means. In a second alternative, a database may have stored thereon the user's previously entered biometric information. The user may be asked to confirm whether this information is correct. If not, the user may be provided with an option to change the information, wherein the user is allowed to change their biometrics information in a manner as discussed above with regard to the first alternative. An example display concerning the user's biometrics is depicted as FIG. 9.

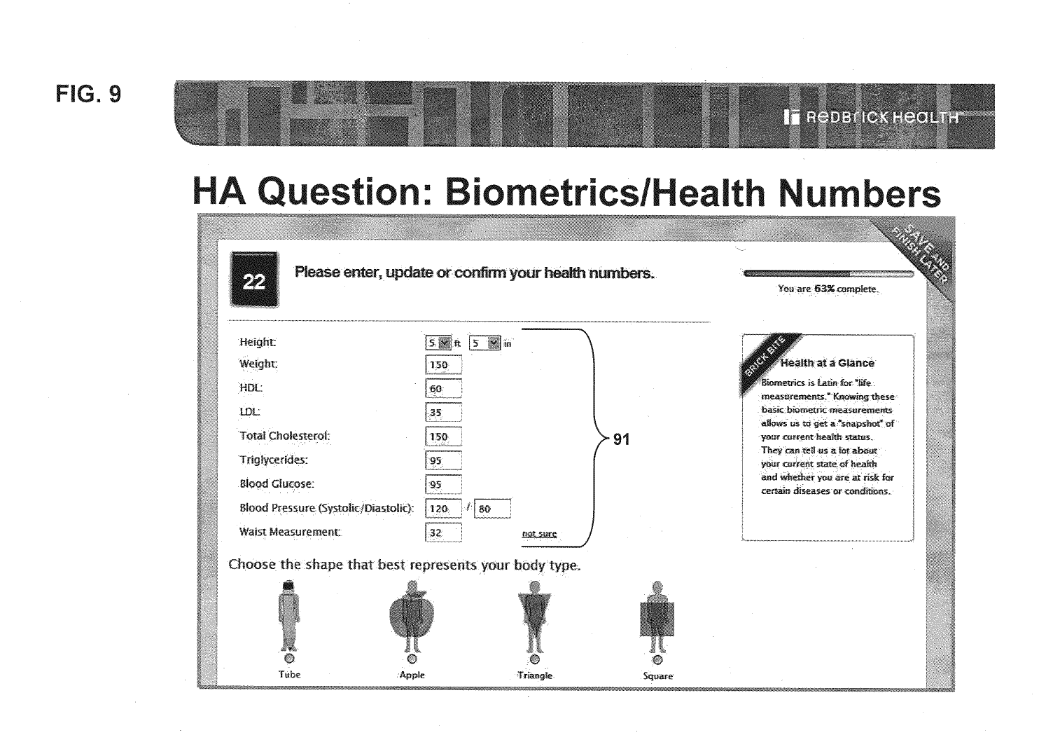

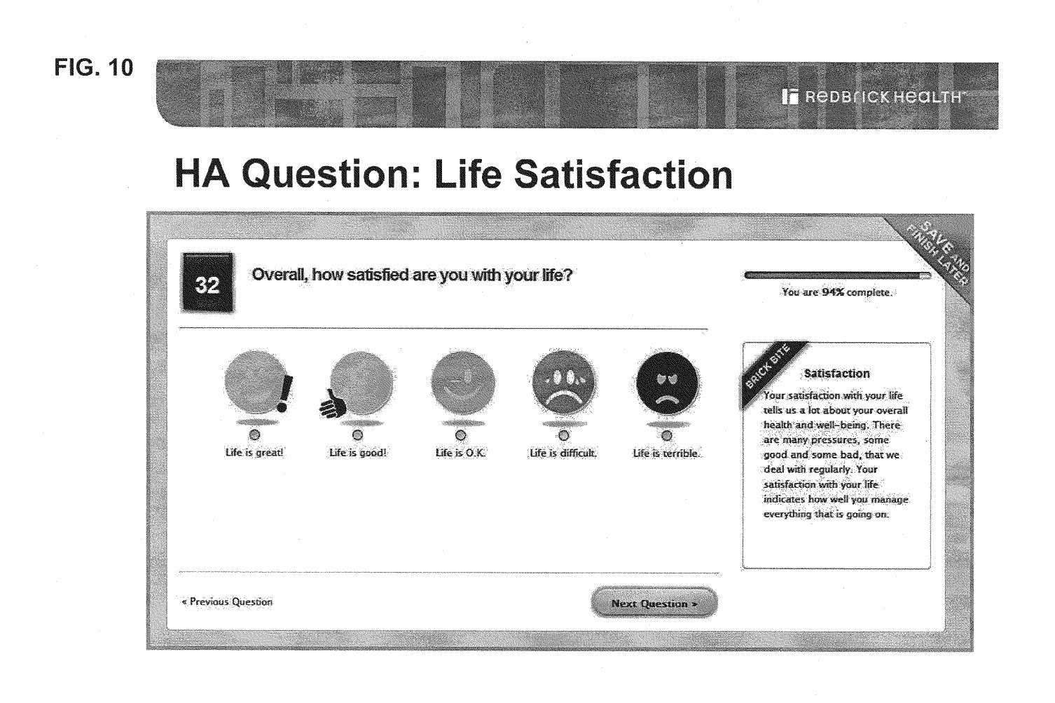

In a life satisfaction display page, the application may be configured to provide the user with a question concerning how satisfied the user is, overall, with their life. For example, the user may be asked to select from one or more choices indicating the user's perceived state of satisfaction. In some embodiments, prior to or concurrently with providing the user with the life satisfaction question, the application may be configured to provide the user with commentary regarding life satisfaction. Such commentary may seek to inform the user of the importance of life satisfaction as related to the user's overall health. For example, the commentary may inform the user that satisfaction with life may be indicative of well-being, and that satisfaction may also be indicative of how well the user is managing the stresses, pressures, and other goings-on in life. In a response display to the life satisfaction question, the user may be provided with one or more options from which to select, indicating the user's current state of satisfaction with their life. In some embodiments, pictorial graphics or icons may be provided in connection with such options. For example, the user may select from among, but not limited to, life is great, life is good, life is O.K., life is difficult, life is terrible, or any other descriptive. Icons provided in connection therewith may take the form of cartoon faces with expression related to the option. For example, a life is great option may have an enthusiastic-appearing smiling face associated therewith. Other options may have other icons or graphics provided therewith in a like manner. The application may be configured to require the user to enter or select a response before further questions will be displayed. An example stress display page is depicted at FIG. 10.

In a question display concerning sleep, the application may be configured to provide the user with a question concerning the typical amount and quality of sleep the user receives in an average night. For example, in one embodiment, the user may be asked to indicate the average number of hours the user sleeps each night, and how the user feels upon awakening. Prior to or concurrently with providing the user with a sleep related question, the application may be configured to provide the user with commentary regarding the question. Such commentary may seek to inform the user of the effects that sleep has on the user's health, work productivity, eating habits, exercise, and mood, among other considerations. In a response display to the sleep question, the user may be provided with a drop-down menu, data field, or other means to enter the number of hours the user sleeps in an average night. The response display, in some embodiments, may be separated into weekday/weekend sleep amounts. Further, the response display may provide the user with options from which to select, indicating how the user feels upon awakening. These options may include, for example, feeling as if the user has not slept at all, feeling very tired and wanting more sleep, feeling refreshed, or feeling energized. In some embodiments, pictorial icons or graphics may be provided in connection with each option to assist the viewer in selecting a response. An option may be selected by, for example, checking a box, or any other suitable data entry means. After the user provides a response to the sleep question, the application may be configured to provide the user with commentary regarding the selection. For example, if the user indicates that they typically receive less than seven hours of sleep per night, the user may be informed that generally, 7-8 hours of sleep is needed to function effectively, and that more sleep may be beneficial to the user's health. Alternatively, if the user indicates that they typically receive greater than nine hours of sleep per night, the user may be informed that there may be underlying health factors contributing to the need for excessive sleep, and that further questions in the assessment may seek to determine the causes or factors contributing to the need for excessive sleep.

In a question display related to the user's work life, the application may be configured to provide the user with a question concerning the user's employment status and/or satisfaction. For example, the user may be asked whether the user is employed, and if so, how satisfied the user is with their current employment. Prior to or concurrently with providing the user with the work life question, the application may be configured to provide the user with commentary regarding their work life. Such commentary may seek to inform the user that, because over one-quarter of the user's adult life may be spent at work, being generally satisfied with working conditions, co-workers, and superiors is important to overall health, including emotional health. In a response display to the work life question, the user may be provided with, for example, a yes or no option regarding whether the user is employed. If yes is selected, the user may further be provided with one or more work satisfaction response options, which may include, but are not limited to, very satisfied, satisfied, neither satisfied nor dissatisfied, dissatisfied, or very dissatisfied, etc. In selecting a response, the user may be provided with commentary in order to assist the user in responding. For example, the application may be configured to inform the user to consider various factors when choosing a response, including but not limited to the user's relationship with their manager, the amount of control the user has over their work, the user's physical work environment, and the people with whom the user works. Selection means may be provided by, for example, check boxes, drop-down menus, or any other means. The application may be configured to require the user to enter or select a response before further questions will be displayed.

In a question related to the user's family history, the application may be configured to provide the user with a question concerning their family history. For example, the user may be asked to indicate whether the user has a family history of certain medical conditions. In some embodiments, the user may be allowed to select from among the following conditions, including but not limited to diabetes, high blood pressure, high cholesterol, cancer, heart problems, and/or other medical conditions. Prior to or concurrently with providing the user with the family history question, the application may be configured to provide the user with commentary regarding the question. Such commentary may seek to provide the user with information concerning the relationship between family history and current or future health conditions. For example, the commentary may inform the user that knowing their family history can help the user to make choices in their current life that may prevent or lessen the risk of acquiring adverse health conditions to which the user may be particularly susceptible. In a response display to the family history question, the user may be asked to select from among the conditions previously mentioned. Such selection may be accomplished by, for example, check box, drop down menu, or other means. The application may be configured to require the user to enter or select a response before further questions will be displayed.

The foregoing questions may be presented to the user in any order and at any time in the health assessment. In other embodiments, some of the questions discussed above may not be asked. For example, some types or categories of questions may be or may become impermissible under certain federal or state laws and regulations. Additional questions not discussed above may also be presented, and the various embodiments disclosed herein are not limited to only the sample types or categories of questions detailed herein. Furthermore, any of the questions may be combined into a single display, or any individual question may be separated into multiple displays. In some embodiments, the user may be allowed to skip questions and return to them later. The user may be allowed to answer questions in whole or in part. Alternatively, the health assessment may be evaluated without the user answering some of the questions at all.

### Health Report and Score

After the user has finished answering all of the questions in the health assessment, the user may be presented with a display page showing a health assessment report and/or score. A health report and score display in accordance with the present disclosure may provide the user with information related to, among other things, the completion of the assessment and potential follow-up steps for the user to complete, information related to the user's score within a range of possible scores as determined from the user's answers to the health questions asked, and information related to the determination of the score.

In one example health report and score display, as depicted in FIG. 11, the user may be presented with assessment completion and/or follow-up information, which may include, for example, an indication that the user has finished the health assessment, an indication that the user may not need to take the assessment again for a length of time, e.g., one year, and information regarding any additional questions that the user may be asked to answer in the interim period until the next health assessment may be required. The health assessment score may be presented as an indication along a scale from 1-100 points, or any other suitable range. An example score of 78 out of 100 is depicted as reference numeral 291 in FIG. 11. Other charts, graphs, scales, or other score depictions, such as by alphabetic grades, are possible. The user may also be presented with information relating to the meaning of a specific score number or range. For example, as depicted in FIG. 11, it is shown with regard to the 0-100 scale that 0 may correspond with a not-so-good assessment, 50 with an average assessment, and 100 with an excellent assessment. Furthermore, the user may be presented with information regarding the details of the composition of the score, which may include, for example, that the user's overall health score may be comprised of sub-scores in the various areas of health asked during the assessment and that the user may view the details of their health assessment individually with regard to each of these areas by clicking, or otherwise indicating, on the respective display or portion thereof. The user may also be provided with information concerning ways to improve the score, for example, by providing section-by-section recommendations to the user to improve each health area assessed. As depicted in FIG. 11, suitable selection icons, such as “Show Details” (reference numeral 292) or “Results” icons, may be provided to advance the system to the desired details/results display, which will be discussed in greater detail below.

A health score in accordance with the present disclosure may be computed based on the answers provided to the questions asked in the assessment. Answers to questions may be translated into numerical values, and these numerical values may be combined into an overall score via an algorithm. Such an algorithm may weigh the answers to certain questions more heavily than others, depending on the relative importance of the question to an individual's health. For example, the user's answer to a question related to cardiovascular risk may be weighted more heavily (and thus contribute greater to the overall health score) than the user's answer to a question related to social support. While specific examples of algorithms will be discussed in greater detail below, it will be appreciated that any scoring algorithm may be constructed, giving greater or lesser weights to the answers to any of the questions presented, and still be within the spirit and scope of the present disclosure. Furthermore, as previously mentioned, because some of the above-described questions may not be asked due to, for example, Federal or state laws, the algorithm may be configured to compute a score without requiring responses to such questions.

A health score algorithm in accordance with one embodiment of the present disclosure may comprise the sum, or other mathematical combination, of topic-specific sub-scores, which in some embodiments may each be further multiplied by a weighting factor. A topic specific sub-score may comprise a numerical value based on the answer to a specific question, or a mathematical combination of such values related to multiple questions within the same topic. Topic-specific sub-scores may include, among others, scores tabulated from questions asked relating to one or more of the following categories: medical health, age, family history, cardiovascular risk, nutrition, weight, tobacco, alcohol, sleep, stress, risk behavior, work life, preventive care, pain, physical activity, outlook, social support, and biometrics. One embodiment of the calculation of topic specific sub-scores will be discussed in greater detail below.

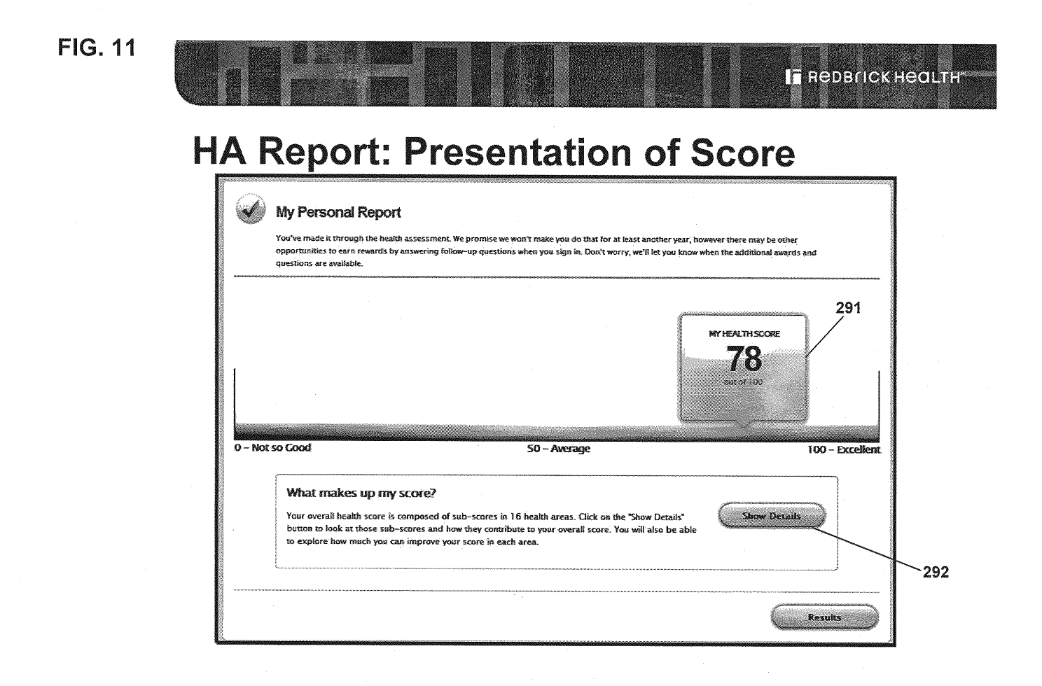

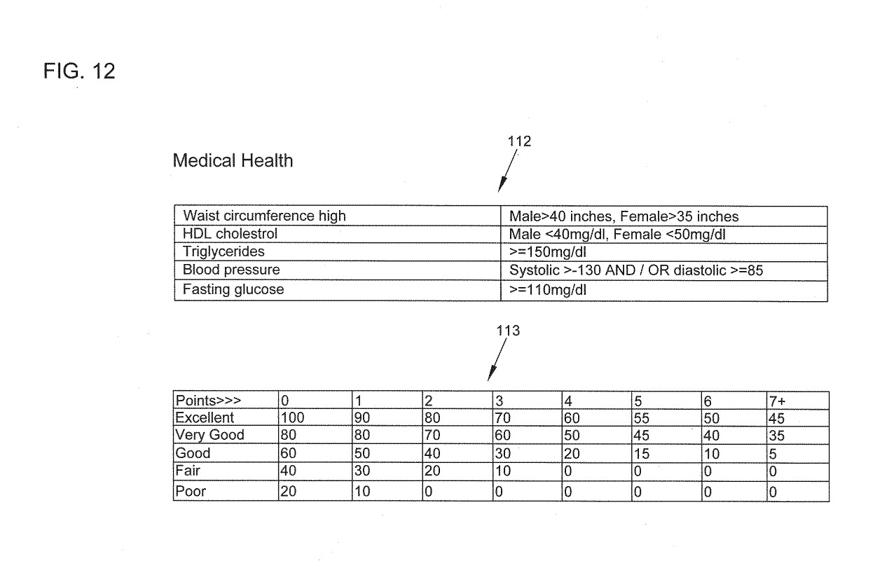

With regard to a medical health sub-score, in one embodiment, the score may comprise the sum of numerical values assigned to a given disease or medical condition which the user has indicated having. For example, a medical condition may be assigned a value of 1, 2, or 3 depending upon its potential impact on the day-to-day life of the user, ease of controlling symptoms, or impact upon the user's long-term health care costs. In some embodiments, the value assigned to a condition may be increased or decreased based on any number of suitable or desirable factors. For example, the value assigned to a condition may be reduced if the user has indicated that they are taking medication for a condition and are receiving care from a doctor. As a further example, the medical-health sub-score may be increased if the user's entered waist circumference, HDL cholesterol, triglycerides, blood pressure, and fasting glucose indicate that they have metabolic syndrome (see FIG. 12, reference numeral 112, wherein example values are provided for scoring). A score, for example, ranging from 0-100 may then be finally calculated based on the above sum, in some embodiments in combination with the user's perception of their own health, as depicted in the example table depicted in FIG. 12, reference numeral 113, although any other mathematical calculation or table of values may be used.

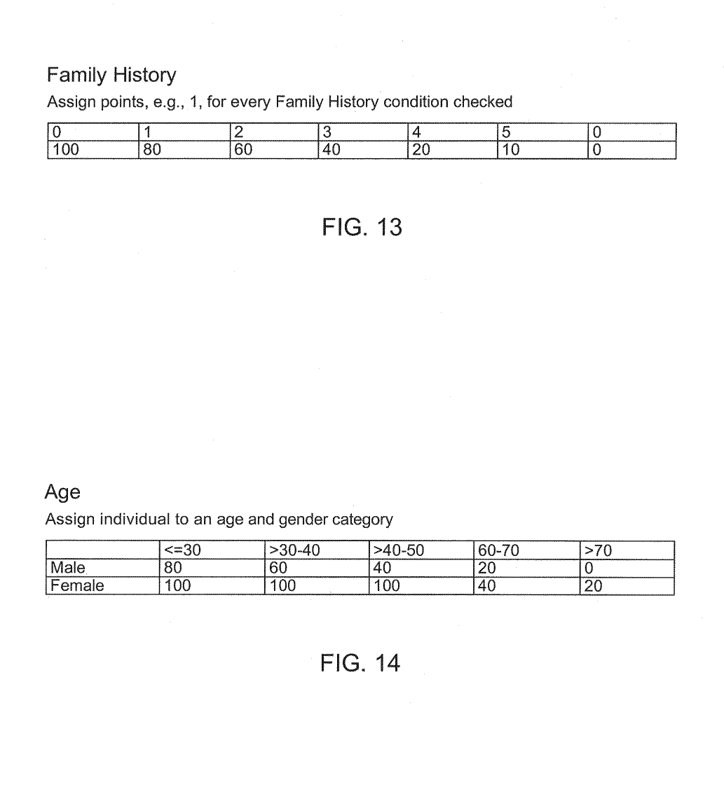

With regard to a family history sub-score, in one embodiment, a score for example from 0-100 may be calculated based on the number of family conditions indicated by the user, according to the example table depicted in FIG. 13, although any other mathematical calculation or table of values may be used.

With regard to an age sub-score, in one embodiment, a score for example from 0-100 may be calculated based on the user's age range and gender, according to the example table depicted in FIG. 14, although any other mathematical calculation or table of values may be used.

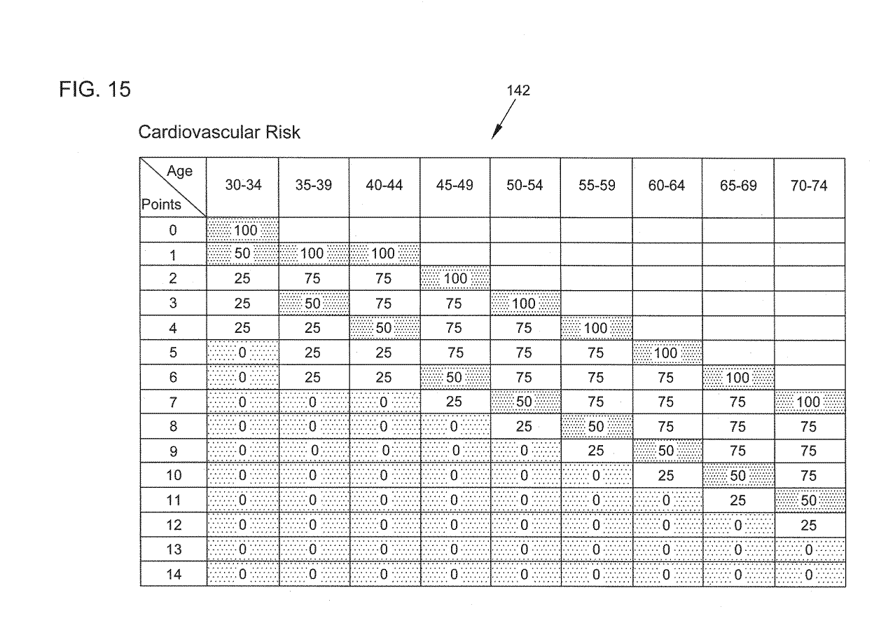

With regard to a cardiovascular risk sub-score, in one embodiment, the score may be calculated based on a series of cardiovascular risk factors and the user's gender. Such risk factors may include, for example, age, total cholesterol, HDL cholesterol, systolic blood pressure, diabetes, and smoking, among others. A score may be calculated using any point values assigned to such conditions, for example, assigning more or fewer points to more or less severe health conditions. This score may then be combined with the user's age to determine the cardiovascular risk sub-score, for example from 0-100, as shown by the example table depicted as reference numeral 142 at FIG. 15, although any other mathematical calculation or table of values may be used.

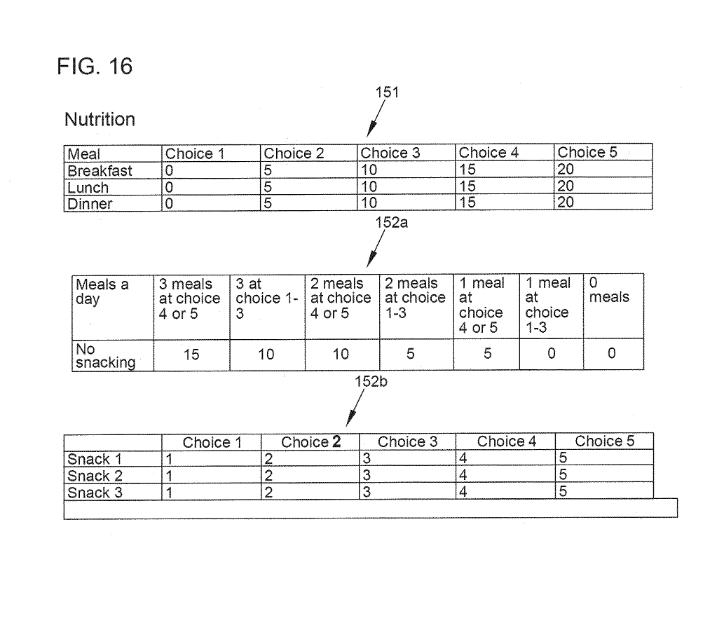

With regard to a nutrition sub-score, in one embodiment, the score may be calculated based on the number of meals the user eats per day, the user's meal choices, the amount the user snacks, and the amount and type of fluids consumed. For example, with respect to the number of meals eaten, 10 points may be assigned for 3 meals, 5 points for two meals, and 0 points for only 1 meal eaten. With respect to the user's meal choices, points may be assigned with reference to the example table shown at FIG. 16, reference numeral 151, although any other mathematical calculation or table of values may be used. The choices 1-5 depicted therein may represent, for example, the example meal choices discussed above with regard to the health assessment question related to nutrition or the example snack choices discussed above with regard to the health assessment question related to snacking, wherein the healthier choice may be awarded greater point totals. With respect to the user's snacking habits, the score assigned may depend upon the number and type of meals eaten, in addition to the number of snacks eaten, as depicted in the example tables shown at reference numerals 152a-b. The example choices 1-5 depicted therein may represent, for example, the example meal choices discussed above with regard to the health assessment question related to nutrition, wherein the healthier choice may be awarded greater point totals. Furthermore, with respect to the user's amount and type of fluids consumed, points may be assigned for the number of non-alcoholic beverages, glasses of water, and soda/tea/coffee consumed, in any manner. To calculate the nutrition sub-score, the points assigned to each of the above-referenced categories (number of meals, type of meals, snack, and fluids) may be summed, resulting in a score for example from 0-100, although any other mathematical calculation or table of values may be used.

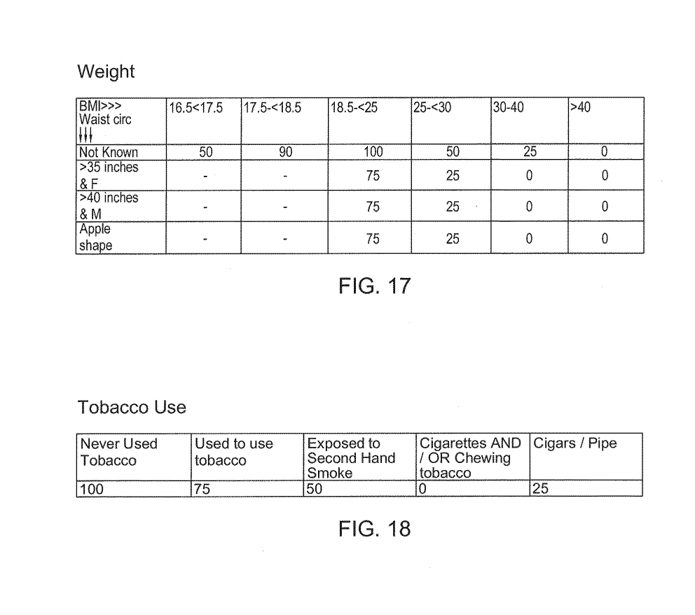

With regard to a weight sub-score, in one embodiment, a score for example from 0-100 may be determined based on the user's body mass index and the user's indicated waist circumference (or shape), as indicated in the example table shown at FIG. 17, although any other mathematical calculation or table of values may be used. The body mass index is calculated as the user's weight in kilograms divided by the user's height in meters, squared.

With regard to a tobacco use sub-score, in one embodiment, a score for example from 0-100 may be calculated based on the frequency and type of the user's tobacco use, including never using tobacco, previously having used tobacco, exposure to second hand smoke, smoking cigarettes or chewing tobacco, and smoking cigars or pipes, as depicted in the table at FIG. 18, although any other mathematical calculation or table of values may be used. The user's sub-score may be modified based on whether the user has had (or has a family history of) cancer, high blood pressure, heart problems, CAD, CHF, or stroke, etc.

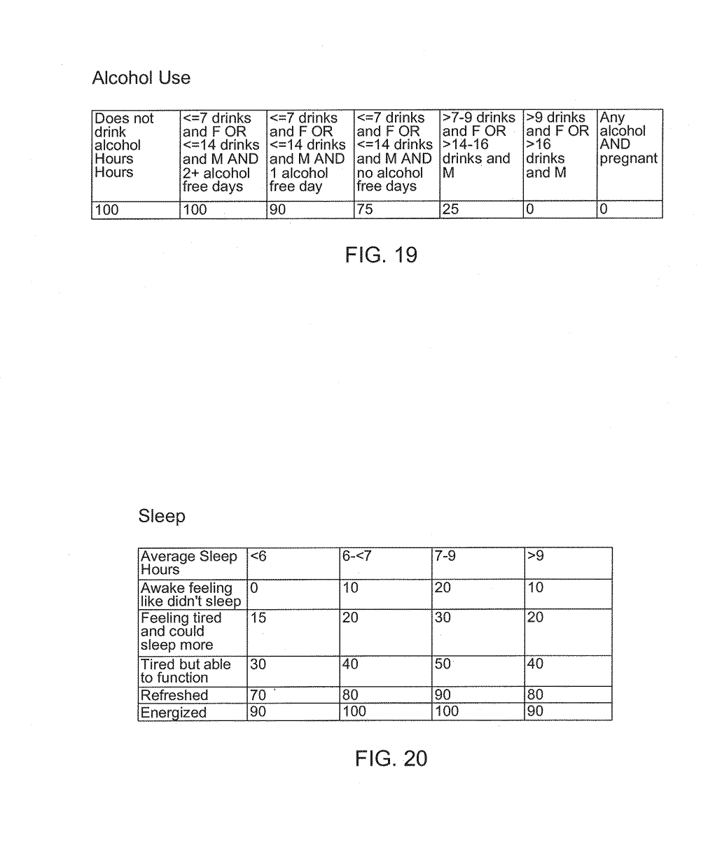

With regard to an alcohol use sub-score, in one embodiment, a score for example from 0-100 may be calculated based on the number of alcoholic beverages the user consumes in a week, and the number of days in a week in which the user does not drink alcohol, as depicted in the example table shown at FIG. 19, although any other mathematical calculation or table of values may be used. This score may be modified if the user is pregnant, or if the user has (or has a family history of) cancer, high blood pressure, CAD, CHF, or premature heart problems.

With regard to a sleep sub-score, in one embodiment, a score for example from 0-100 may be calculated based on the average number of weekday and weekend sleep hours the user receives and on the user's indicated feeling upon awakening, as depicted in the example table shown at FIG. 20, although any other mathematical calculation or table of values may be used. The user's indicated feeling upon awakening may include, for example but is not limited to, awakening feeling like the user did not sleep, feeling tired and could sleep more, tired but able to function, refreshed, or energized.

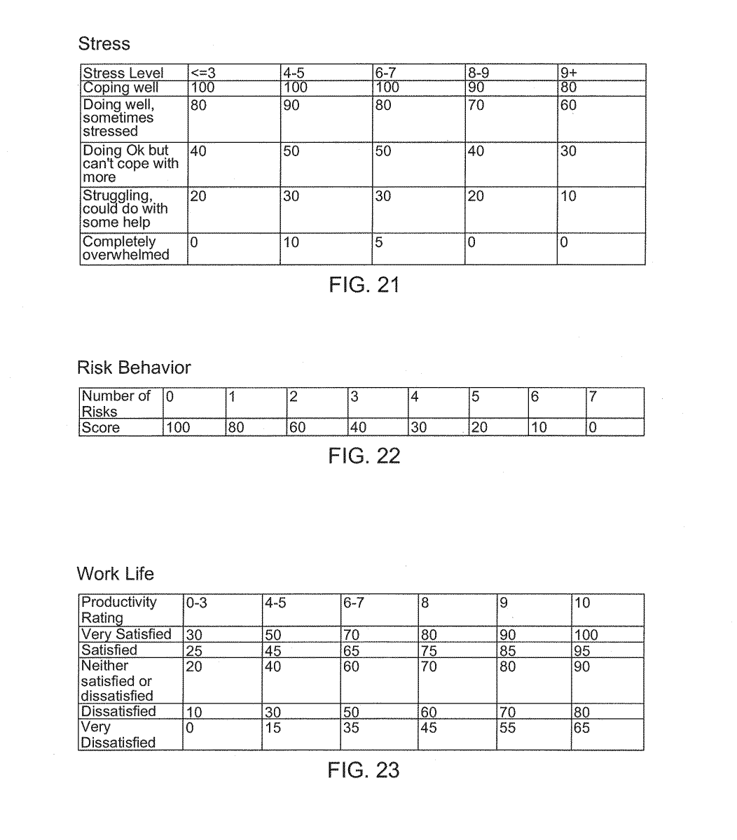

With regard to a stress sub-score, in one embodiment, a score for example from 0-100 may be calculated based on the user's indicated stress level (as a score from 1-10), and how the user manages stress, as depicted in the example table shown at FIG. 21. How the user manages stress may include, for example but is not limited to coping well, doing well but sometimes stressed, doing OK but can't cope with more, struggling, could do with some help, and completely overwhelmed.

With regard to a risk behavior sub-score, a score for example from 0-100 may be calculated based on the number of risks the user has indicated as engaging in, according to the example table depicted at FIG. 22, although any other mathematical calculation or table of values may be used.

With regard to a work life sub-score, in one embodiment, a score for example from 0-100 may be calculated based upon the user's productivity (e.g., as indicated on a scale from 1-10) and on how satisfied the user is with their work, as shown in the example table depicted at FIG. 23, although any other mathematical calculation or table of values may be used. Work satisfaction may be classified as, but is not limited to, very satisfied, satisfied, neither satisfied nor dissatisfied, dissatisfied, or very dissatisfied. The score may be adjusted depending on whether the user has been absent from work in the past three months. If the user has been absent for a period of time, for example, one or more days, points may be subtracted; if the user has been absent for a greater period of time, for example, five or more days, a greater number of points may be subtracted. Greater or lesser points may be subtracted or awarded in a like manner, or in any other manner, for other periods of absence.

With regard to a preventive care sub-score, in one embodiment, points may be awarded if the user has completed any of a given set of preventive medical procedures, determined by the user's age and gender. These procedures may include, but are not limited to, pap smear and clinical breast exams for women over 18 years, mammogram every one to two years for women over 40 years, annual flu shot for users over 50 years or diabetic, pneumonia vaccine for users under 65 years or diabetic (and once again for users over 65 years), bone density test for women over 65 years, cholesterol test once every five years for users over 20 years, blood pressure test at least every two years for users over 18 years, and colon cancer screenings every 5 to 10 years for users over 50 years and/or other suitable procedures. In one embodiment, the ratio of points awarded for completed procedures, divided by the total number of points possible, based on the user's age and gender, may be multiplied by for example 100 to determine the final preventive care sub-score, although any other mathematical calculation or table of values may be used.

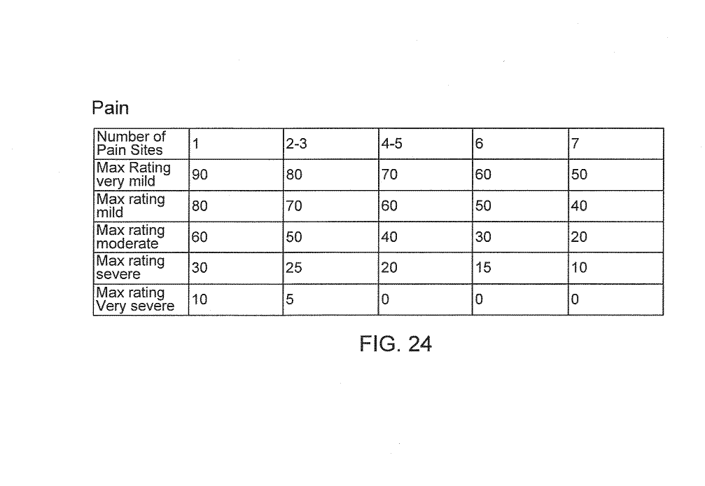

With regard to a pain sub-score, in one embodiment, a score for example from 0-100 may be calculated based on the number of pain sites a user has and the severity of the pain, in accordance with the example chart depicted at FIG. 24, although any other mathematical calculation or table of values may be used.

With regard to a physical activity level sub-score, in one embodiment, a score for example from 0-100 may be calculated based on the amount of time spent exercising, and the level of intensity of the exercise (e.g., on a scale from 1 to 6). The score may be based on the amount of time spent exercising at each level of intensity. In some embodiments, a “METS” (metabolic equivalents) workload may be required. In one embodiment, the METS workload may be calculated for each activity level, and summed for the total workload. Then, a score can be determined based on rules of workload expended over the different intensity levels.

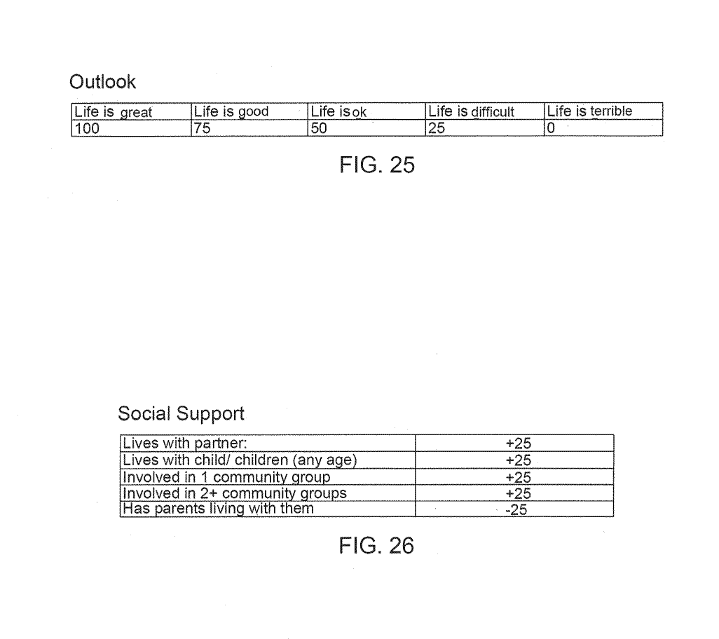

With regard to an outlook sub-score, in one embodiment, a score for example from 0-100 may be calculated based on the user's indicated life outlook, in accordance, for example, with the sample table depicted at FIG. 25, although any other mathematical calculation or table of values may be used. Possible life outlooks may include for example but are not limited to, life is great, life is good, life is OK, life is difficult, or life is terrible.

With regard to a social support sub-score, in one embodiment, a score for example from 0-100 may be calculated as the sum of any number of factors, each worth some specific point value, if present. The factors may include, for example but not limited to, lives with partner, lives with child/children (of any age), involved in one community group, involved in two or more community groups. Additionally, points may be subtracted from the social support sub-score if the user has parents living with them, or based on any other suitable factor. The table depicted in FIG. 26 shows some sample point values which may be used, although any other mathematical calculation or table of values may be used.

With regard to a biometrics sub-score, in one embodiment, points may be awarded to a user based on whether the user has a full set of biometrics stored on the health assessment system, has entered these biometrics during the course of the health assessment, or has been made available to the health assessment system in any other manner. In one example, the full amount of points available for the biometrics sub-score may be awarded to a user if a full set of their biometrics is stored. These biometrics can include, for example, height, weight, blood pressure, LDL cholesterol, HDL cholesterol, total cholesterol, triglycerides, blood glucose, and waist circumference/body shape. If less than all of the biometrics have been stored/entered, but the user indicated that he or she has an appointment scheduled with a doctor to ascertain these values, then lesser points than if the user had a full set stored may be awarded. If no or incomplete information is stored, and the user does not provide or does not indicate that they will provide such biometric information, then, in one embodiment, no points may be awarded. Other scoring systems/calculations/tables may also be used to award points in a biometrics sub-score, including awarding points based on the individual values of the biometric information provided for or by the user.

As previously indicated, a health score algorithm in accordance with the present disclosure may assign a weight value to each calculated topic-specific sub-score to calculate a health score. In one embodiment, the weighting factor may be multiplied by each respective sub-score, and then the sums totaled. In embodiments wherein each sub-score is based on a scale for example from 1-100, and wherein the weighting is provided as percentage, then the total health score may also be on a scale from 1-100.

Algorithms may be modified to account for the user's non-modifiable characteristics, which may include the user's age, family history, and gender, among others. Accounting for these non-modifiable factors, for example by creating an “adjusted score,” can help normalize a user's score based on the fact that the user has non-modifiable conditions—and due to these non-modifiable conditions, the user may not ever be able to achieve what would be considered a perfect health score (a score which does not account for these factors, i.e., scoring the user against a perfectly healthy person, may be referred to herein as a “real score”). Thus, an adjusted score may allow the user to achieve a perfect score of 100 relative to people in like condition, if the user has generally done what he/she could to improve health, while using a real score, that user may never be able to achieve a perfect score because of their age, gender, or family history.

In some embodiments, the real score may be calculated by multiplying each sub-score by its weighting factor, and then summing over all sub-scores. The adjusted score may be calculated by multiplying each sub-score by its weighting factor, dividing by the maximum score that the user could have achieved for that particular sub-category, and then summing over all sub-scores.

In some embodiments of the present disclosure, the real score may not be provided to the user but may be provided by the health assessment system only to the user's employer as part of a population level report based on the employer's overall work force. Only the adjusted score may then be presented to the user in a health report score display as previously discussed (see FIG. 11) such that the user has the potential to realize a perfect score if the necessary changes are made to the user's health related behaviors and/or modifiable health conditions.

The health assessment system may also provide the user with a report, based on the user's score. Such a report may include score details, recommendations, and recommended programs. The report may add a component of interactivity and education to the health assessment system, and enables the user to plan for changes in their behaviors and health conditions, which may result in an improved score at a subsequent assessment. Users may be more motivated to improve their score if presented with a report that presents specific recommendations derived from the answers to the questions asked, rather than general, non-specific health improvement information.

In a display related to the details of the user's score, the user may be presented with a list of health categories, based on the topic-specific sub-scores calculated by the system, which may be improved to achieve a higher score. Each category may be accompanied by an indication as to the user's relative performance or rating in the respective category. For example, each category may be accompanied by an indication as to whether the particular category scored as “excellent,” “good,” “fair,” or “poor,” or any other relative indication. This indication may be presented with an appropriate pictorial graphic or icon, indicating the status as excellent, good, fair, or poor, etc. For example, a poor score may be indicated with an exclamation point, providing an indication to the user that action may be desirable. Each category may further be accompanied by information or commentary related to the health risks which may be experienced if the user continues with their present behavior/health condition and does not improve their score in that particular category. For example, a user with a poor score in the alcohol consumption category may be informed that high alcohol consumption may lead to adverse health conditions, such as heart disease or liver disease. Additionally, information may be provided to the user with suggestions to improve their score in a category which has been indicated as fair or poor. For example, a user with a poor cardiovascular risk may be presented with suggestions to reduce fat consumption and increase fiber consumption.

The score details display may further provide the user with the option to see how their overall score would improve if a category indicated as fair, poor, or other less than perfect rating, were improved. For example, an icon or text link may be provided next to each listed health category. The icon may indicate to the user that selecting the icon may allow the user to see how such component score or category may affect their overall score. Selecting or clicking on this icon or text link may result in an additional window being displayed, showing the user's current health score as compared to a potential health score the user could achieve if that category were improved. In one embodiment, this potential health score may be calculated by replacing the user's current topic-specific sub-score in the respective category with a perfect score or other suitable score or adjusted score, and recalculating. As will be appreciated by those having ordinary skill in the art, replacing the user's topic-specific sub-score with any score that is higher than the user's current score may result in an increased potential score to display to the user.

In some embodiments, users can input potential future changes in behavior and lifestyle, for example but not limited to, quitting smoking, increased exercises, low-fat diets, etc. to see where and how much their personal health score might change if such behaviors or lifestyle changes were made. Inputs may be made using onscreen sliders or other input methods, such as but not limited to, typing in parameters directly, allowing a user to adjust health parameters up or down from their current values, etc. For example, a user may investigate the effect that weight loss or a reduction in cholesterol levels may have on a personal health score. Typically, a change in one or more health parameters may dynamically update or change a personal health score.

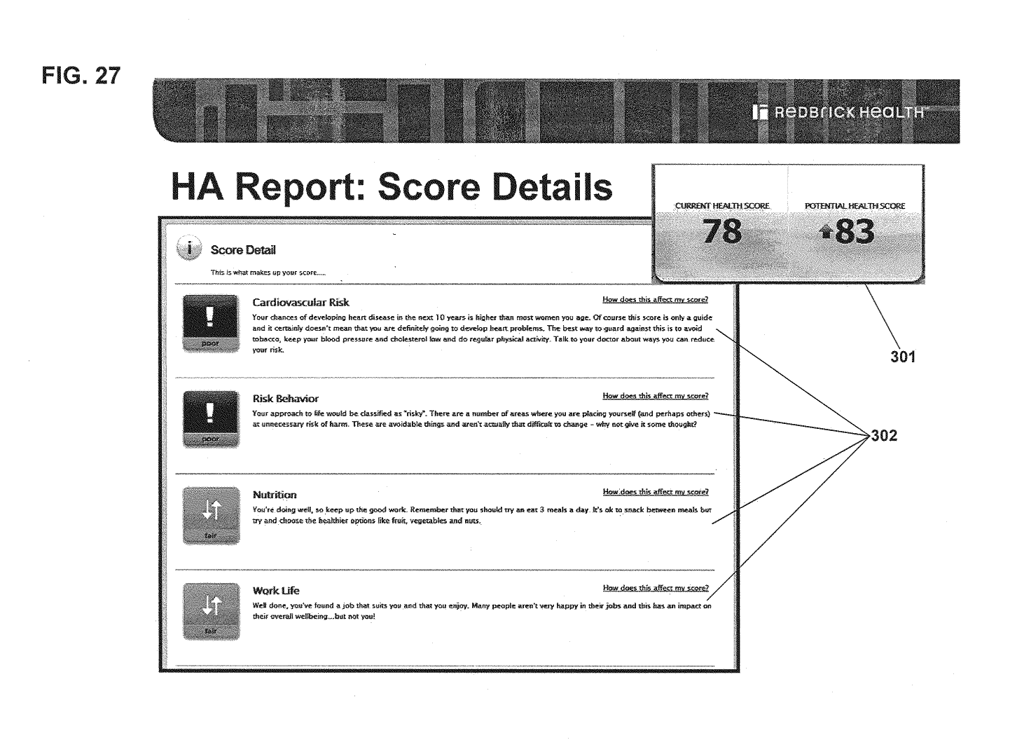

FIG. 27 depicts an example score details display in accordance with the present disclosure. As shown therein, a score detail text box may provide the user with an indication that the user's score is comprised of the listed components or categories. As shown in the figure, the user has indicators of poor for cardiovascular risk and risk behavior, and indicators of fair for the categories of nutrition and work life. The information provided in connection with the cardiovascular risk category may inform the user that the user's chances of developing heart disease in the coming years may be higher than average for the user's age group and/or gender. The user may further be informed that the best way to prevent heart disease may be to avoid tobacco, reduce blood pressure, and/or engage in regular physical activity. Other relevant health suggestions or health improvement and wellness referrals may also be provided. The information provided in connection with the risk behavior category may inform the user that based on the answers provided by the user, the user may be in a classification that is at a greater risk for injury or other adverse health conditions. The user may also be informed that there are a number of areas where the user may be placing himself/herself or others at risk of injury or other adverse health conditions, and that a change in the indicated behaviors may help to avoid such risks. The information provided in connection with the nutrition category may inform the user that the user is generally consuming a balanced diet, that it may be beneficial to eat three meals per day, and that if the user snacks, fruits or vegetables may be appropriate snacking options. Other relevant health-related information may also be provided. The information provided in connection with the work life category may inform the user that it may be beneficial for the user's overall health that the user has found a job that they enjoy, in contrast to many people who may not enjoy their job and thus may suffer adverse health effects. As will be appreciated, the information provided in FIG. 27 is merely representative of information that may be provided in various embodiments, and further that the information provided in FIG. 27 is directed to the sample user outcome shown. In practice, any relevant information may be provided to a user in connection with a given user outcome. At reference numeral 302, FIG. 27 further depicts a link in connection with each category. When the user clicks on this link, a window or other display mechanism, shown as reference numeral 301, may appear which indicates the user's current health score (78) in comparison to the user's potential health score (83, with an “up” arrow icon indicating the possible improvement) which could be achieved if the user were to take steps to improve their behaviors/health conditions in connection with this category.

A recommendations display page may also be presented to the user. A recommendations display page may include a paragraph listing of health behaviors/conditions/categories in which the user is doing well, meaning the user has scored a relatively good or high topic-specific sub-score related to the listed category. Additionally, the user may be presented with a paragraph listing of health behaviors/conditions/categories in which the user may benefit from improvement, meaning the user has scored a relatively fair or low topic-specific sub-score related to the listed categories. Commentary may be provided in connection with each listed category. Such information may be congratulatory in nature, where the user has a high or relatively good score, or the information may be suggestive in nature, where the user has a low or relatively poor score and may need to make improvements in their behaviors or health conditions. Other educational or general purpose information may also be provided related to the categories in which the user has scored high or low. Furthermore, with regard to the listed behaviors/conditions/categories which may need improvement, the user may again be presented with the option (in the form of an icon or text link, for example) to see their potential health score if improvements were made, similar to that provided to the user on the score details page as discussed above.

In some embodiments, the score detail display, as depicted in FIG. 27, and the recommendations and recommended programs provided therewith, may be provided to the user in ranked order. Such ranking may be based on, for example, the importance of each category in relation to the user's health. Such recommendations or recommended programs may be provided in real time to the user, immediately upon completing the assessment, in order to keep the user engaged in the process, and thus increasing the chances that the user will follow-up with and complete the recommendations or recommended programs.

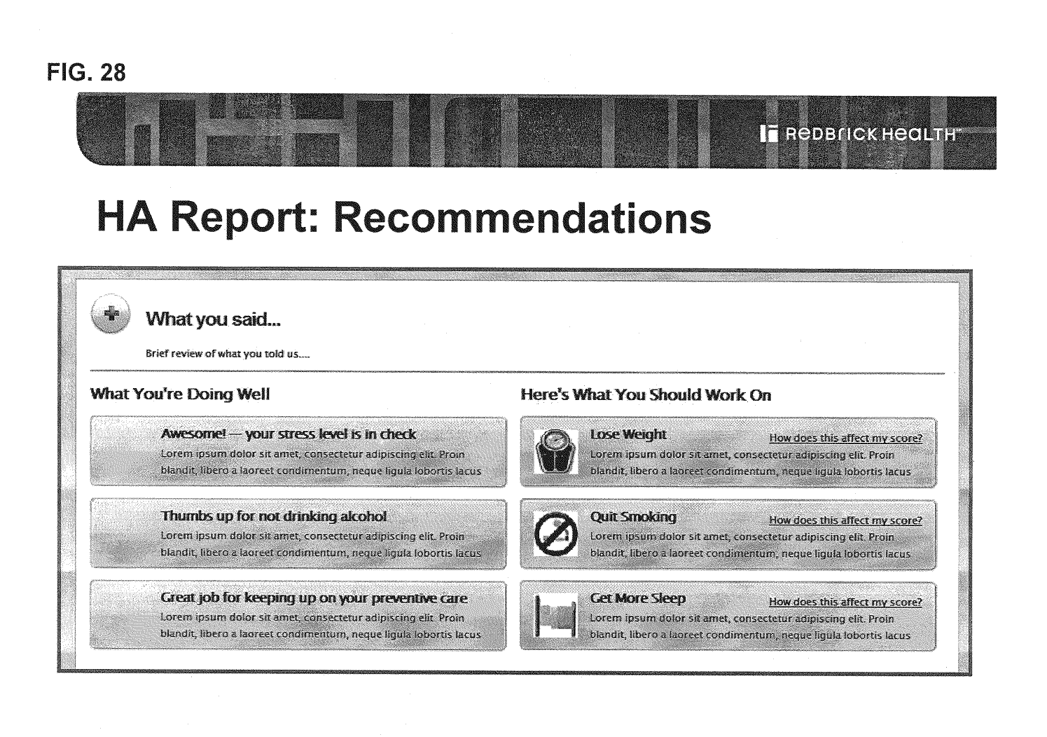

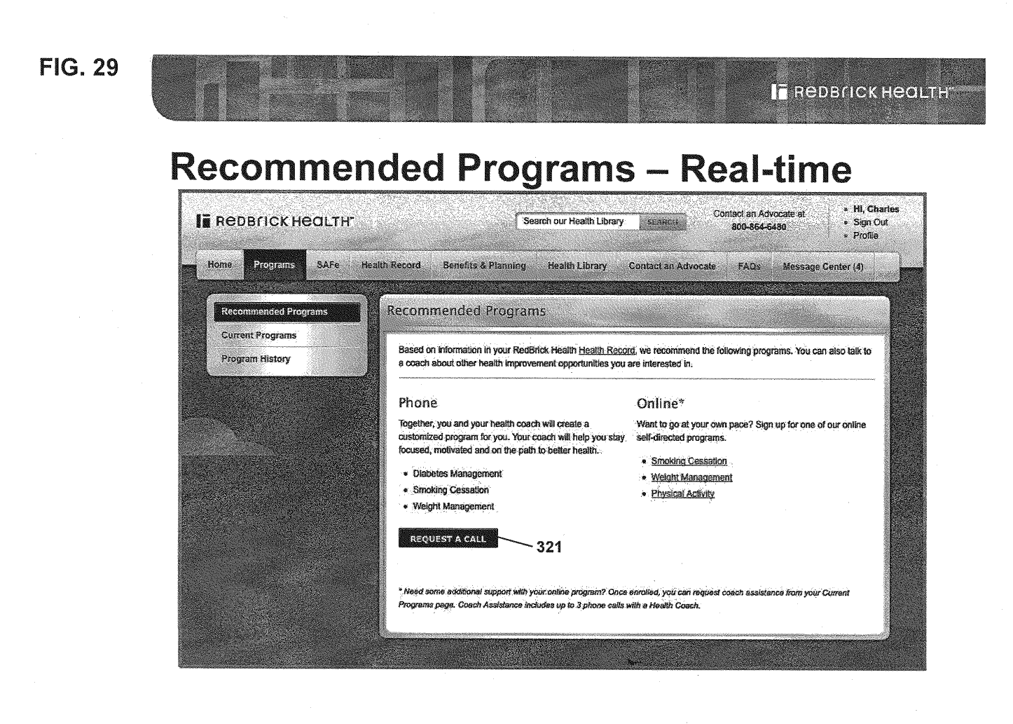

An example recommendations display page is depicted as FIG. 28. As shown therein, a text box may indicate that the user is being provided with a brief review of the answers that the user provided to the various health questions during the health assessment. Under a paragraph listing the categories in which the user has scored relatively well, three health behaviors/conditions/categories are listed (stress, alcohol, preventive care), with associated explanatory information. Congratulatory information may be used to encourage the user, such as “Awesome!—your stress level is in check;” “Thumbs up for not drinking alcohol;” and/or “Great job for keeping up on your preventive care.” Under a paragraph listing the categories in which the user has scored relatively poorly, three health behaviors/conditions/categories are listed (weight, smoking, sleep), with associated explanatory information. Suggestive information may be used to encourage the user to change their behaviors or to seek help improving their health conditions, such as “Lose Weight;” “Quit Smoking;” and/or “Get More Sleep.” Associated with each indicated relatively fair or poor item may be a link which, when selected, may cause a window or other display mechanism to appear comparing the user's current score to the user's potential score if the listed health behavior or condition were improved.

A recommended programs display page may also be provided to the user. A recommended programs display page may include information concerning programs or coaching which may help the user improve health conditions, for example those that were scored as fair or poor in the health assessment. Programs and coaching may be provided online, over the phone, in person, or any other suitable means. The recommended programs display page may list the coaching/programs options which are available to the user in any of the available media. Furthermore, the recommended programs display page may provide the user with hyperlinks to internet media programs/coaching, and it may provide the user with the option to request a call for phone-based programs/coaching. By providing the user with easy access to programs and coaching, the user may be more motivated to use the programs and coaching, thus increasing the chances of the user improving their health. Furthermore, with these options provided substantially immediately after the health assessment, when the information provided is still fresh in the user's mind, the user may be less likely to procrastinate or avoid utilizing the programs and coaching.

FIG. 29 depicts an example recommended programs display page. Information may be provided to the user indicating the options available, for example, that based on information that the user has provided, certain programs or other assistance may be recommended to help the user improve their health. Furthermore, an option may be presented wherein the user may be provided with contact information to speak to a personal health coach about some or all of the health issues identified by the health assessment. This display page may also list possible over-the-phone coaching options such as diabetes management, smoking cessation, and/or weight management. It may also list possible online programs, such as smoking cessation, weight management, and/or physical activity. Other programs may be made available as well. In connection with the phone options, an icon (reference numeral 321) may be provided for the user to request a call. In connection with the internet options, the programs may be provided as internet hyperlinks to the respective program website. However, other suitable methods of directing the user to such programs and coaching may be used.

### Benefits:

Benefits which may be realized by the disclosed health assessment include, among others, relatively fast completion time, collection of only information for a general or baseline assessment and to generate a health score, interactive and intuitive questioning to keep the user attentive/interested, which may include various graphics and dialogue boxes, two-way interaction wherein the user provides information to the system and the system in turn provides information to the user, an educational, engaging, and enjoyable experience for the user, and actionable suggestions provided to the user for improving health.

Although the present disclosure has been described with reference to various embodiments, persons skilled in the art will recognize that changes may be made in form and detail without departing from the spirit and scope of the invention.

What is claimed is:

1. A method for determining a quantitative assessment of health comprising:
displaying, in electronic format on an electronic display device, one or more questions related to a first health condition and a second health condition;
receiving, in electronic format, information representing an assessment of the first health condition and the second health condition, the information being provided by user manipulation of an input device, responsive to the one or more questions;
transforming the information representing the first health condition into a first numerical value and transforming the information representing the second health condition into a second numerical value, wherein the first and second numerical values represent quantitative scores of the respective first and second health conditions; and
applying a mathematical algorithm to at least the first and second numerical values, wherein the mathematical algorithm provides a final numerical score as a function of at least the first and second numerical values, and wherein the final numerical score represents a quantitative assessment of overall health.

2. The method of claim 1, wherein the electronic information representing the assessment of the first and second health conditions is provided by a user in response to electronically presented questions regarding the first and second health conditions.

3. The method of claim 2, further comprising displaying the final numerical score to the user on the electronic display device in an electronic display format.

4. The method of claim 2, wherein the first health condition belongs to a first health category, wherein the second health condition belongs to a second health category, and wherein, in addition to the final numerical score, the user is provided with a first health category score and a second health category score, the first and second health category scores being functions of the first and second numerical values, respectively.

5. The method of claim 1, further comprising:
receiving additional electronic information representing an assessment of the first health condition that is different than the initially received information regarding the first health condition;
transforming the additional information representing the first health condition into a third numerical value, wherein the third numerical value represents a quantitative score of the first health condition; and
applying the mathematical algorithm to the second and third numerical values, wherein the mathematical algorithm provides a revised final numerical score as a function of the second and third numerical values.

6. The method of claim 5, wherein the additional electronic information represents a hypothetical assessment of the first health condition provided by a user seeking to determine the effects of a change to the first health condition.

7. The method of claim 1, wherein the mathematical algorithm is configured to provide a final numerical score as a function of three or more numerical values.

8. The method of claim 1, wherein differing assessments of health conditions are transformed into differing numerical values.

9. The method of claim 1, wherein the algorithm assigns weighting factors to the first and second numerical values.

10. The method of claim 9, wherein the weighting factors assigned to the first and second numerical values are based on the relative importance of the first health condition to a person's overall health as compared to the second health condition.

11. The method of claim 9, wherein the algorithm comprises a linear or exponential combination of the first and second numerical values.

12. The method of claim 1, wherein the final numerical score is normalized based on a highest possible score.

13. The method of claim 12, wherein the highest possible score represents a hypothetical score based on the user achieving a best possible assessment, particular to the user, for each respective health condition assessed.

14. The method of claim 12, wherein normalization comprises a linear function of the final numerical score and the highest possible score.

15. The method of claim 1, further comprising providing a user with information regarding actions that the user can take to receive a higher final numerical score.

16. The method of claim 1, further comprising providing a qualitative assessment of the final numerical score, wherein the qualitative assessment represents an indication of overall health.

17. A method for providing an interactive health assessment comprising:
selecting, from an electronic database, a question pertaining to a health condition of a user;
displaying, in electronic format on an electronic display device, the question;
receiving, in electronic format, data representing an answer to the first question, the data being provided by user manipulation of an input device, wherein the answer represents the user's assessment of the health condition;
selecting, from the electronic database, responsive information pertaining to the answer, wherein the responsive information represents commentary regarding the assessment of the health condition; and
displaying, in electronic format on the electronic display device, the responsive information.

18. The method of claim 17, wherein the commentary regarding the assessment of the health condition comprises information for helping the user to improve the health condition.

19. The method of claim 17, wherein the commentary regarding the assessment of the health condition comprises information for contacting a health service provider regarding the health condition.

20. A method for providing an interactive health assessment comprising:
selecting, from an electronic database, a question pertaining to a health condition of a user;
selecting, from the electronic database, a user engaging feature for association with the question, wherein the user engaging feature provides a visual representation related to the question;
displaying, in electronic format on an electronic display device, the question and the user engaging feature; and
receiving, in electronic format, data representing an answer to the first question, the data being provided by user manipulation of an input device, wherein the answer represents an assessment of the health condition.

21. The method of claim 20 further comprising displaying a plurality of answer options along with the question and wherein the user engaging feature comprises at least one visual indicator associated with the plurality of answer options.

22. A computer-implemented system for providing an interactive health assessment comprising:
a user terminal, comprising:
an electronic display device;
an electronic user input device; and
a processor in operable communication with display device and the user input device;
wherein the processor is configured to:
cause the display device to display a question pertaining to a health condition;
receive a user input from the user input device, the user input representing an assessment of the health condition;
transform the user input into a numerical health score, the numerical health score representing a quantitative assessment of the user's health; and
cause the display device to display generally immediate feedback information pertaining to at least one of the user input and the numerical health score.
